(19) United States
(12) Patent Application Publication
(10) Pub. No.: US 2026/0122520 A1
(43) Pub. Date: Apr. 30, 2026

(54) SIGNALING OF ENVIRONMENT INFORMATION FROM A SENSING COMPONENT

(71) Applicant: QUALCOMM Incorporated, San Diego, CA (US)

(72) Inventors: Marwen ZORGUI, San Diego, CA (US); Mohammed Ali Mohammed HIRZALLAH, San Marcos, CA (US); Bapineedu Chowdary GUMMADI, Hyderabad (IN)

(21) Appl. No.: 18/926,801

(22) Filed: Oct. 25, 2024

(51) Int. Cl. H04W 24/10; H04B 7/04; H04B 7/06; H04W 8/22; H04W 64/00

(52) U.S. Cl. CPC H04W 24/10; H04B 7/04013; H04B 7/0626; H04W 8/22; H04W 64/00

(57) ABSTRACT

Aspects of the disclosure are directed to signaling of environment information from a sensing component. In an aspect, the sensing component may correspond to a sensing server (or sensing management function (SnMF)) or a sensing node (e.g., a wireless node capable of receiving and measuring sensing signals for monostatic sensing or bistatic sensing). In an aspect, utilizing environment information from a sensing component (e.g., as opposed to coarse radio frequency (RF) environment information which is tracked by a location management function (LMF)) may facilitate various technical advantages, such as improving sensing and/or position estimation accuracy and/or reducing sensing and/or position estimation latency, improving beam management procedure(s) and/or a channel state information (CSI) procedure(s), and so on.

### TECHNICAL FIELD

Aspects of the disclosure relate generally to wireless technologies.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), RF sensing, and other technical enhancements. These enhancements, as well as the use of higher frequency bands, enable improved RF sensing and 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method performed by a device includes transmitting an environment information request; receiving, from a sensing component in response to the environment information request, environment information associated with a wireless node; and performing one or more actions related to a measurement session based on the environment information.

In an aspect, a method of operating a sensing component includes receiving an environment information request; determining environment information associated wireless node; and transmitting, to a device in response to the environment information request, an indication of the environment information in association with a measurement session.

In an aspect, a device includes one or more memories; one or more transceivers; and one or more processors communicatively coupled to the one or more memories and the one or more transceivers, the one or more processors, either alone or in combination, being configured to: transmit, via the one or more transceivers, an environment information request; receive, via the one or more transceivers, from a sensing component in response to the environment information request, environment information associated with a wireless node; and perform one or more actions related to a measurement session based on the environment information.

In an aspect, a sensing component includes one or more memories; one or more transceivers; and one or more processors communicatively coupled to the one or more memories and the one or more transceivers, the one or more processors, either alone or in combination, being configured to: receive, via the one or more transceivers, an environment information request; determine environment information associated wireless node; and transmit, via the one or more transceivers, to a device in response to the environment information request, an indication of the environment information in association with a measurement session.

In an aspect, a device includes means for transmitting an environment information request; means for receiving, from a sensing component in response to the environment information request, environment information associated with a wireless node; and means for performing one or more actions related to a measurement session based on the environment information.

In an aspect, a sensing component includes means for receiving an environment information request; means for determining environment information associated wireless node; and means for transmitting, to a device in response to the environment information request, an indication of the environment information in association with a measurement session.

In an aspect, a non-transitory computer-readable medium storing computer-executable instructions that, when executed by a device, cause the device to: transmit an environment information request; receive, from a sensing component in response to the environment information request, environment information associated with a wireless node; and perform one or more actions related to a measurement session based on the environment information.

In an aspect, a non-transitory computer-readable medium storing computer-executable instructions that, when executed by a sensing component, cause the sensing component to: receive an environment information request; determine environment information associated wireless node; and transmit, to a device in response to the environment information request, an indication of the environment information in association with a measurement session.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIGS. 4A and 4B illustrate different types of wireless sensing, according to aspects of the disclosure.

FIGS. 5A to 5F illustrate various example monostatic and bistatic sensing use cases, according to aspects of the disclosure.

FIG. 6 illustrates an example call flow for a New Radio (NR)-based sensing procedure in which the network configures the sensing parameters, according to aspects of the disclosure.

FIG. 7 illustrates an example Long-Term Evolution (LTE) positioning protocol (LPP) call flow between a UE and a location server for performing positioning operations.

FIG. 8 illustrates an example neural network, according to aspects of the disclosure.

FIG. 9A is a diagram illustrating an example of direct artificial intelligence/machine learning (AIML) positioning and/or sensing, according to aspects of the disclosure.

FIG. 9B is a diagram illustrating an example of AIML assisted positioning and/or sensing, according to aspects of the disclosure.

FIG. 9C illustrates various AIML positioning and/or sensing scenarios, according to aspects of the disclosure.

FIG. 10 illustrates a “scheduled location time” position estimation session in accordance with aspects of the disclosure.

FIG. 11 illustrates an exemplary process of communications according to an aspect of the disclosure.

FIG. 12 illustrates an exemplary process of communications according to an aspect of the disclosure.

FIG. 13 illustrates an example implementation of the processes of FIGS. 11-12, respectively, in accordance with aspects of the disclosure.

FIG. 14 illustrates an example implementation of the processes of FIGS. 11-12, respectively, in accordance with aspects of the disclosure.

FIG. 15 illustrates an example implementation of the processes of FIGS. 11-12, respectively, in accordance with aspects of the disclosure.

FIG. 16 illustrates an example implementation of the processes of FIGS. 11-12, respectively, in accordance with aspects of the disclosure.

FIG. 17 illustrates an example implementation of the processes of FIGS. 11-12, respectively, in accordance with aspects of the disclosure.

FIG. 18 illustrates an example implementation of the processes of FIGS. 11-12, respectively, in accordance with aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

In some designs, a location management function (LMF) may provide a user equipment (UE) with a description of the multipath in the current UE area, using the “Environment” field which provides coarse radio frequency (RF) environment information. In some designs, using the “Environment” information, the user equipment (UE) may adequately adapt its processing techniques to match the characteristics of the propagation environment. However, the information obtained from the location management function (LMF) is very coarse. Additionally, in some designs, the information may be not accurate or may be stale, as the LMF is not expected to have appropriate means to assess the environment of the UE area.

Particular aspects of the subject matter described in this disclosure can be implemented to realize one or more of the following potential advantages. Aspects of the disclosure are directed to signaling of environment information from a sensing component. In an aspect, the sensing component may correspond to a sensing server (or sensing management function (SnMF)) or a sensing node (e.g., a wireless node capable of receiving and measuring sensing signals for monostatic sensing or bistatic sensing). In an aspect, utilizing environment information from a sensing component (e.g., as opposed to coarse radio frequency (RF) environment information which is tracked by a location management function (LMF)) may facilitate various technical advantages, such as improving sensing and/or position estimation accuracy and/or reducing sensing and/or position estimation latency, improving beam management procedure(s) and/or a channel state information (CSI) procedure(s), and so on.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

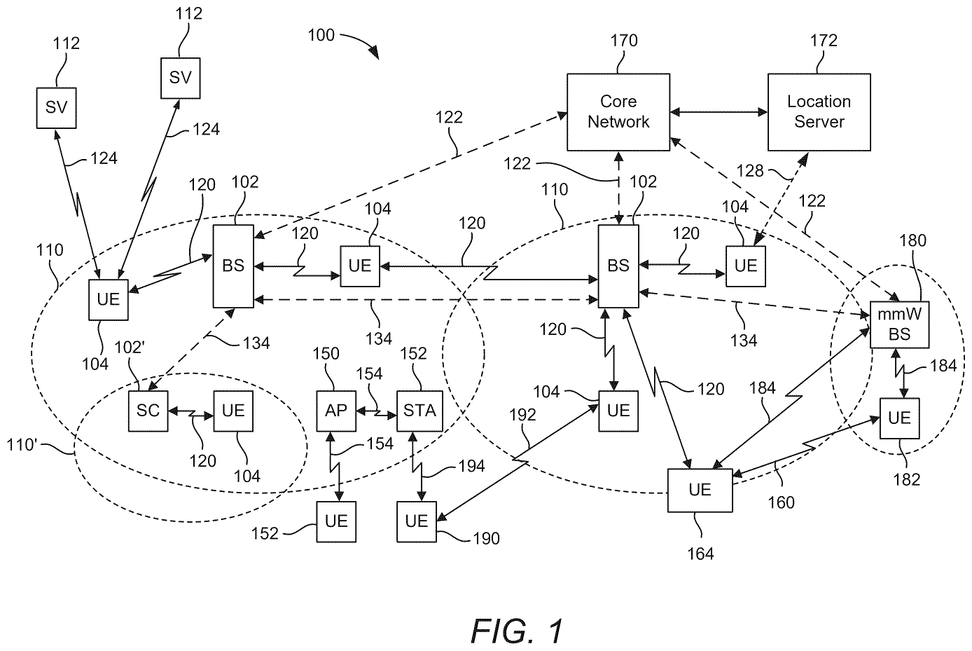

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

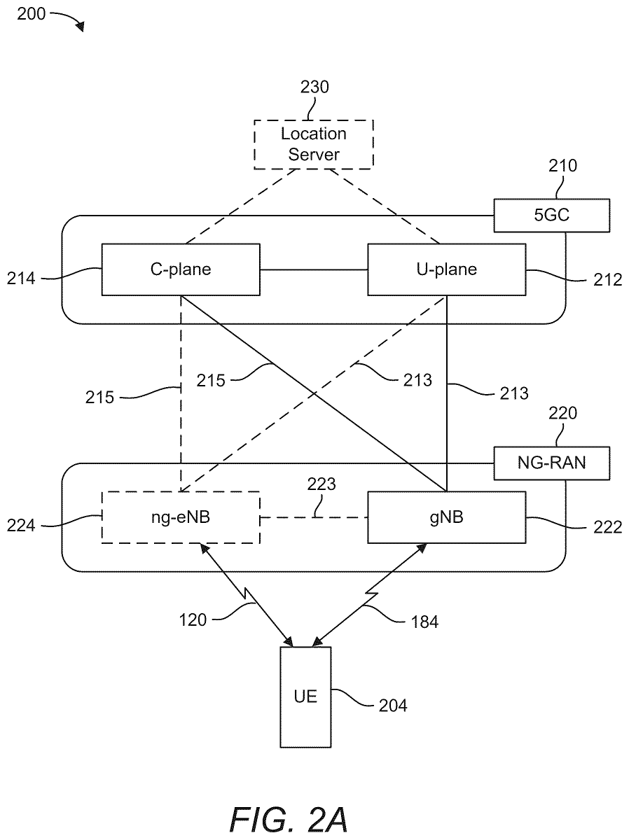

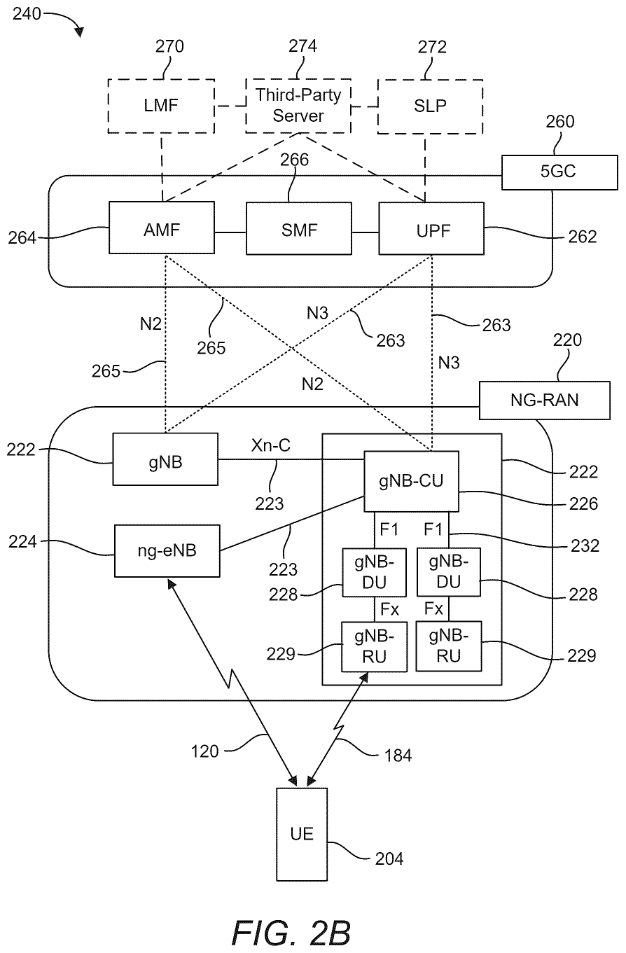

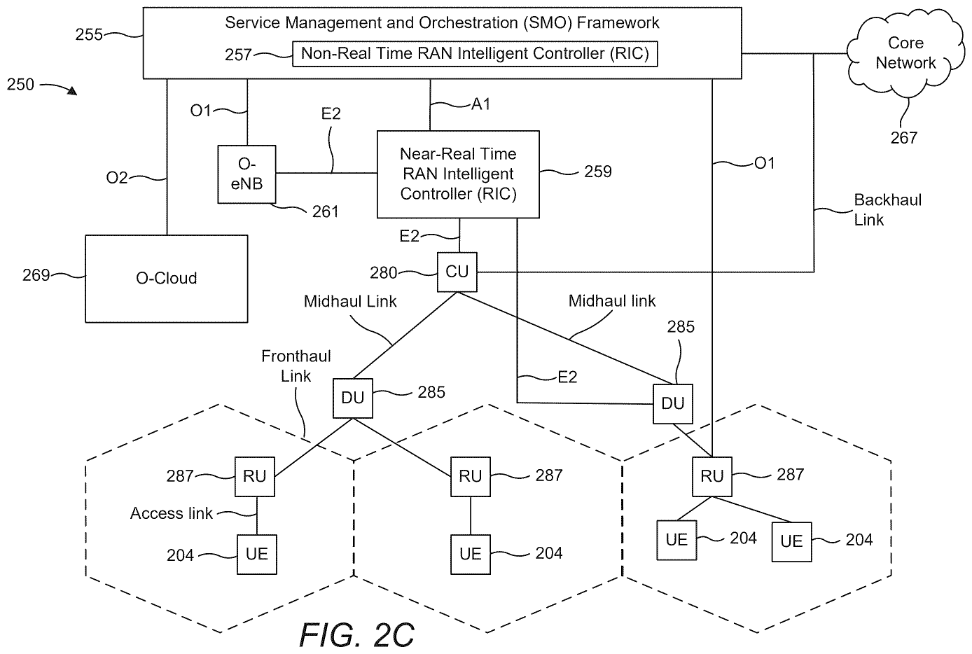

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via 01) or via creation of RAN management policies (such as A1 policies).

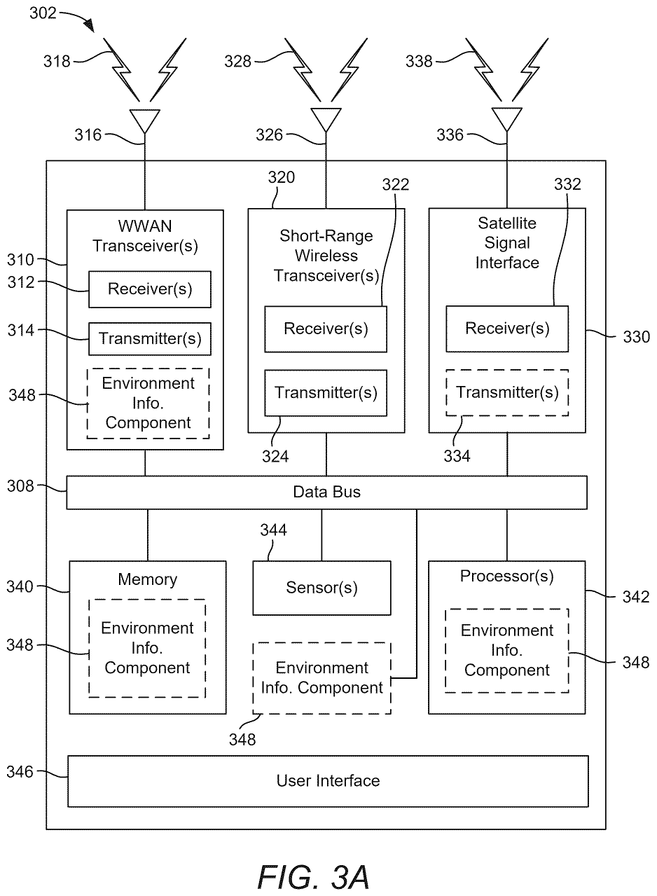

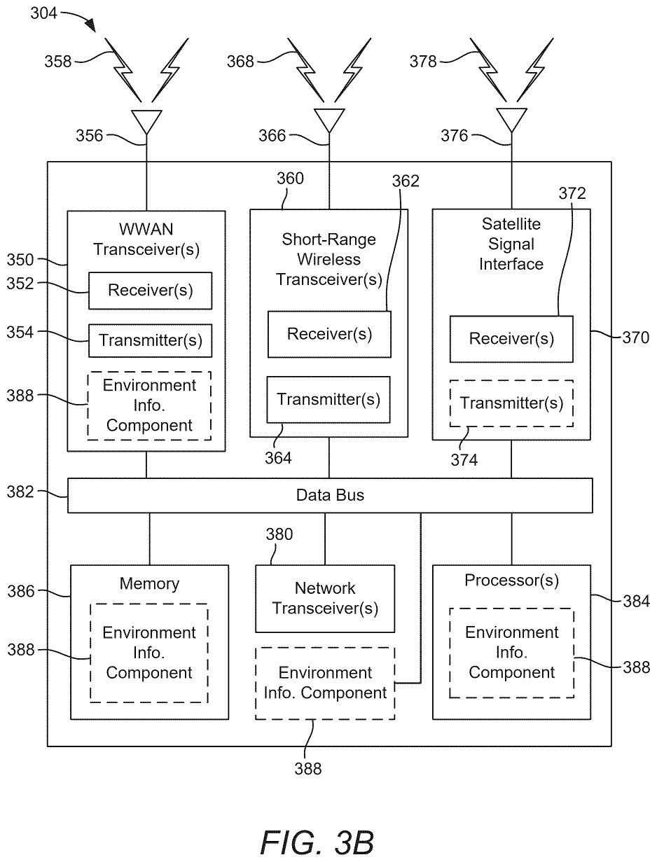

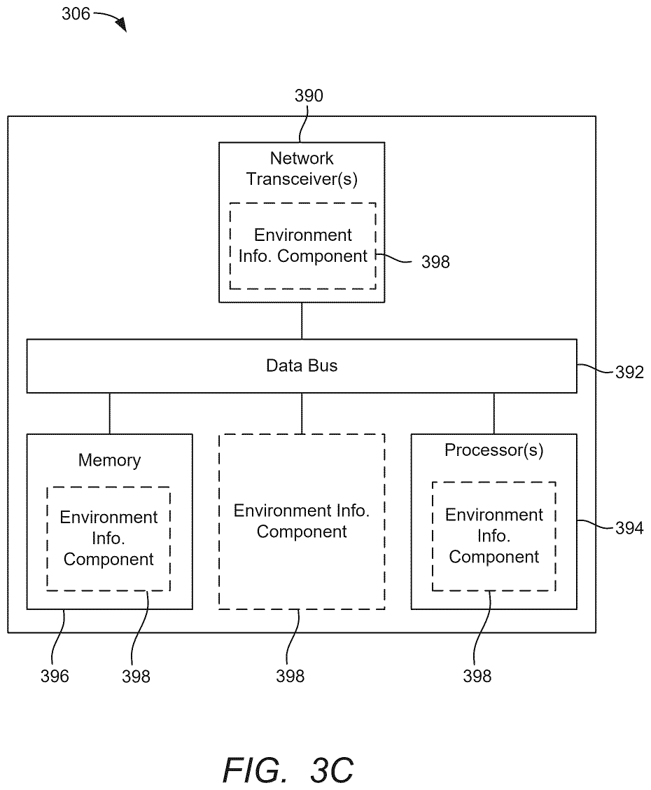

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include environment information component 348, 388, and 398, respectively. The environment information component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the environment information component 348, 388, and 398 may be external to the processors 342, 384, and 394 (e.g., part of a modem processing system, integrated with another processing system, etc.). Alternatively, the environment information component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the environment information component 348, which may be, for example, part of the one or more WWAN transceivers 310, the memory 340, the one or more processors 342, or any combination thereof, or may be a standalone component. FIG. 3B illustrates possible locations of the environment information component 388, which may be, for example, part of the one or more WWAN transceivers 350, the memory 386, the one or more processors 384, or any combination thereof, or may be a standalone component. FIG. 3C illustrates possible locations of the environment information component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the environment information component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

Note that the UE 302 illustrated in FIG. 3A may represent a “reduced capability” (“RedCap”) UE or a “premium” UE. As described further below, while RedCap and premium UEs may have the same types of components (e.g., both may have one or more WWAN transceivers 310, one or more short-range wireless transceivers 320, satellite signal interface 330, one or more processors 342, memory 340, etc.), the components may have different degrees of functionality (e.g., increased or decreased performance, more or fewer capabilities, etc.) depending on whether the UE 302 corresponds to a RedCap UE or a premium UE.

UEs may be classified as RedCap UEs (e.g., wearables, such as smart watches, glasses, rings, etc.) and premium UEs (e.g., smartphones, tablet computers, laptop computers, etc.). RedCap UEs may alternatively be referred to as low-tier UEs, light UEs, or super light UEs. Premium UEs may alternatively be referred to as full-capability UEs or simply UEs. RedCap UEs generally have lower baseband processing capability, fewer antennas (e.g., one receiver antenna as baseline in FR1 or FR2, two receiver antennas optionally), lower operational bandwidth capabilities (e.g., 20 MHz for FR1 with no supplemental uplink or carrier aggregation, or 50 or 100 MHz for FR2), only half duplex frequency division duplex (HD-FDD) capability, smaller HARQ buffer, reduced physical downlink control channel (PDCCH) monitoring, restricted modulation (e.g., 64 QAM for downlink and 16 QAM for uplink), relaxed processing timeline requirements, and/or lower uplink transmission power compared to premium UEs. Different UE tiers can be differentiated by UE category and/or by UE capability. For example, certain types of UEs may be assigned a classification (e.g., by the original equipment manufacturer (OEM), the applicable wireless communications standards, or the like) of “RedCap” and other types of UEs may be assigned a classification of “premium.” Certain tiers of UEs may also report their type (e.g., “RedCap” or “premium”) to the network. Additionally, certain resources and/or channels may be dedicated to certain types of UEs.

As will be appreciated, the accuracy of RedCap UE positioning may be limited. For example, a RedCap UE may operate on a reduced bandwidth, such as 5 to 20 MHz for wearable devices and “relaxed” IoT devices (i.e., IoT devices with relaxed, or lower, capability parameters, such as lower throughput, relaxed delay requirements, lower energy consumption, etc.), which results in lower positioning accuracy. As another example, a RedCap UE's receive processing capability may be limited due to its lower cost RF/baseband. As such, the reliability of measurements and positioning computations would be reduced. In addition, such a RedCap UE may not be able to receive multiple PRS from multiple TRPs, further reducing positioning accuracy. As yet another example, the transmit power of a RedCap UE may be reduced, meaning there would be a lower quality of uplink measurements for RedCap UE positioning.

Premium UEs generally have a larger form factor and are costlier than RedCap UEs, and have more features and capabilities than RedCap UEs. For example, with respect to positioning, a premium UE may operate on the full PRS bandwidth, such as 100 MHz, and measure PRS from more TRPs than RedCap UEs, both of which result in higher positioning accuracy. As another example, a premium UE's receive processing capability may be higher (e.g., faster) due to its higher-capability RF/baseband. In addition, the transmit power of a premium UE may be higher than that of a RedCap UE. As such, the reliability of measurements and positioning computations would be increased.

Wireless communication signals (e.g., radio frequency (RF) signals configured to carry orthogonal frequency division multiplexing (OFDM) symbols in accordance with a wireless communications standard, such as LTE, NR, etc.) transmitted between a UE and a base station can be used for environment sensing (also referred to as “RF sensing” or “wireless sensing”). Using wireless communication signals for environment sensing can be regarded as consumer-level wireless sensing with advanced detection capabilities that enable, among other things, touchless/device-free interaction with a device/system. The wireless communication signals may be cellular communication signals, such as LTE or NR signals, WLAN signals, such as Wi-Fi signals, etc. As a particular example, the wireless communication signals may be an OFDM waveform as utilized in LTE and NR. High-frequency communication signals, such as millimeter wave (mmW) RF signals, are especially beneficial to use as sensing signals because the higher frequency provides, at least, more accurate range (distance) detection.

Possible use cases of RF sensing include health monitoring use cases, such as heartbeat detection, respiration rate monitoring, and the like, gesture recognition use cases, such as human activity recognition, keystroke detection, sign language recognition, and the like, contextual information acquisition use cases, such as location detection/tracking, direction finding, range estimation, and the like, and automotive sensing use cases, such as smart cruise control, collision avoidance, and the like.

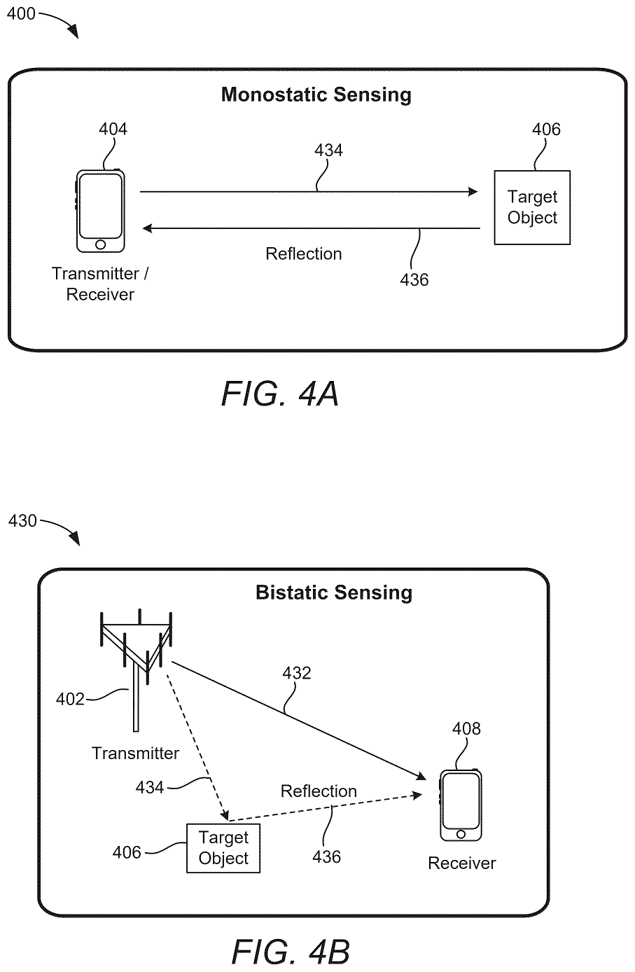

There are different types of sensing, including monostatic sensing (also referred to as “active sensing”) and bistatic sensing (also referred to as “passive sensing”). FIGS. 4A and 4B illustrate these different types of sensing. Specifically, FIG. 4A is a diagram 400 illustrating a monostatic sensing scenario and FIG. 4B is a diagram 430 illustrating a bistatic sensing scenario. In FIG. 4A, the transmitter (Tx) and receiver (Rx) are co-located in the same sensing device 404 (e.g., a UE). The sensing device 404 transmits one or more RF sensing signals 434 (e.g., uplink or sidelink positioning reference signals (PRS) where the sensing device 404 is a UE), and some of the RF sensing signals 434 reflect off a target object 406 (e.g., an unmanned aerial vehicle (UAV)). The sensing device 404 can measure various properties (e.g., times of arrival (ToAs), angles of arrival (AoAs), phase shift, etc.) of the reflections 436 of the RF sensing signals 434 to determine characteristics of the target object 406 (e.g., size, shape, speed, motion state, etc.).

In FIG. 4B, the transmitter (Tx) and receiver (Rx) are not co-located, that is, they are separate devices (e.g., a UE and a base station). Note that while FIG. 4B illustrates using a downlink RF signal as the RF sensing signal 432, uplink RF signals or sidelink RF signals can also be used as RF sensing signals 432. In a downlink scenario, as shown, the transmitter device 402 is a base station (e.g., a gNB) and the receiver device 408 is a UE (e.g., a mobile phone, a V2X-capable vehicle, a roadside unit (RSU), etc.), whereas in an uplink scenario, the transmitter device 402 is a UE and the receiver device 408 is a base station. Where the transmitter device 402 is a base station and the receiver device 408 a UE, the sensing is referred to as UE-assisted sensing. In UE-assisted sensing, the position of receiver device 408 should be known by the network (e.g., by GPS or other UE positioning method).

Referring to FIG. 4B in greater detail, the transmitter device 402 transmits RF sensing signals 432 and 434 (e.g., positioning reference signals (PRS)) to the receiver device 408, but some of the RF sensing signals 434 reflect off a target object 406. The receiver device 408 (also referred to as the “sensing device”) can measure the times of arrival (ToAs) of the RF sensing signals 432 received directly from the transmitter device 402 and the ToAs of the reflections 436 of the RF sensing signals 434 reflected from the target object 406.

More specifically, as described above, a transmitter device (e.g., a base station) may transmit a single RF signal or multiple RF signals to a receiver device (e.g., a UE). However, the receiver may receive multiple RF signals corresponding to each transmitted RF signal due to the propagation characteristics of RF signals through multipath channels. Each path may be associated with a cluster of one or more channel taps. Generally, the time at which the receiver detects the first cluster of channel taps is considered the ToA of the RF signal on the line-of-site (LOS) path (i.e., the shortest path between the transmitter and the receiver). Later clusters of channel taps are considered to have reflected off objects between the transmitter and the receiver and therefore to have followed non-LOS (NLOS) paths between the transmitter and the receiver.

Thus, referring back to FIG. 4B, the RF sensing signals 432 followed the LOS path between the transmitter device 402 and the receiver device 408, and the RF sensing signals 434 followed an NLOS path between the transmitter device 402 and the receiver device 408 due to reflecting off the target object 406. The transmitter device 402 may have transmitted multiple RF sensing signals 432, 434, some of which followed the LOS path and others of which followed the NLOS path. Alternatively, the transmitter device 402 may have transmitted a single RF sensing signal in a broad enough beam that a portion of the RF sensing signal followed the LOS path (RF sensing signal 432) and a portion of the RF sensing signal followed the NLOS path (RF sensing signal 434).

Based on the ToA of the LOS path, the ToA of the NLOS path, and the speed of light, the receiver device 408 can determine the distance to the target object(s). For example, the receiver device 408 can calculate the distance to the target object as the difference between the ToA of the LOS path and the ToA of the NLOS path multiplied by the speed of light. In addition, if the receiver device 408 is capable of receive beamforming, the receiver device 408 may be able to determine the general direction to a target object 406 as the direction (angle) of the receive beam on which the RF sensing signal following the NLOS path was received. That is, the receiver device 408 may determine the direction to the target object 406 as the AoA of the RF sensing signal, which is the angle of the receive beam used to receive the RF sensing signal. The receiver device 408 may then optionally report this information to the transmitter device 402, its serving base station, an application server associated with the core network, an external client, a third-party application, or some other sensing entity. Alternatively, the receiver device 408 may report the ToA measurements to the transmitter device 402, or other sensing entity (e.g., if the receiver device 408 does not have the processing capability to perform the calculations itself), and the transmitter device 402 may determine the distance and, optionally, the direction to the target object 406.

Note that if the RF sensing signals are uplink RF signals transmitted by a UE to a base station, the base station would perform object detection based on the uplink RF signals just like the UE does based on the downlink RF signals.

Like conventional wireless sensing, wireless communication-based sensing signals can be used to estimate the range (distance), velocity (Doppler), and angle (AoA) of a target object. However, the performance (e.g., resolution and maximum values of range, velocity, and angle) may depend on the design of the reference signal.

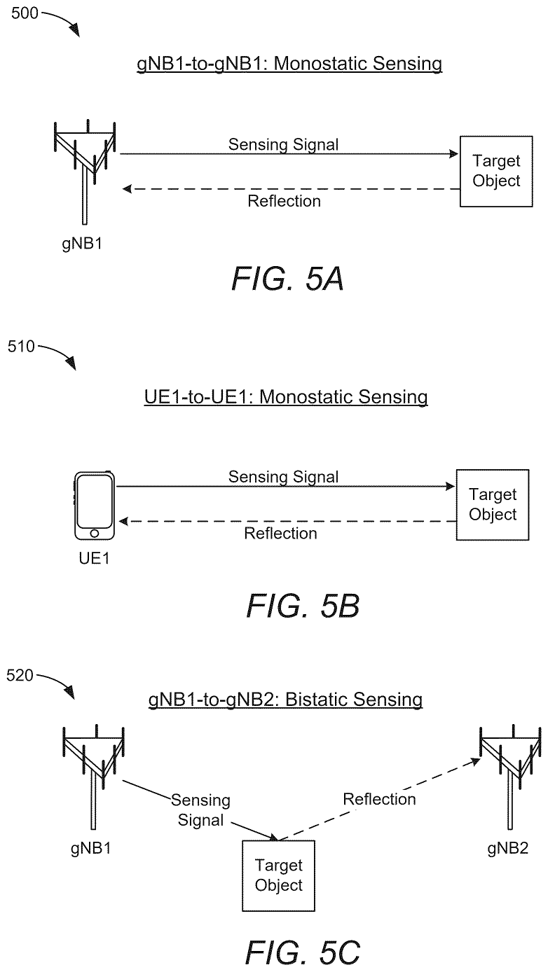

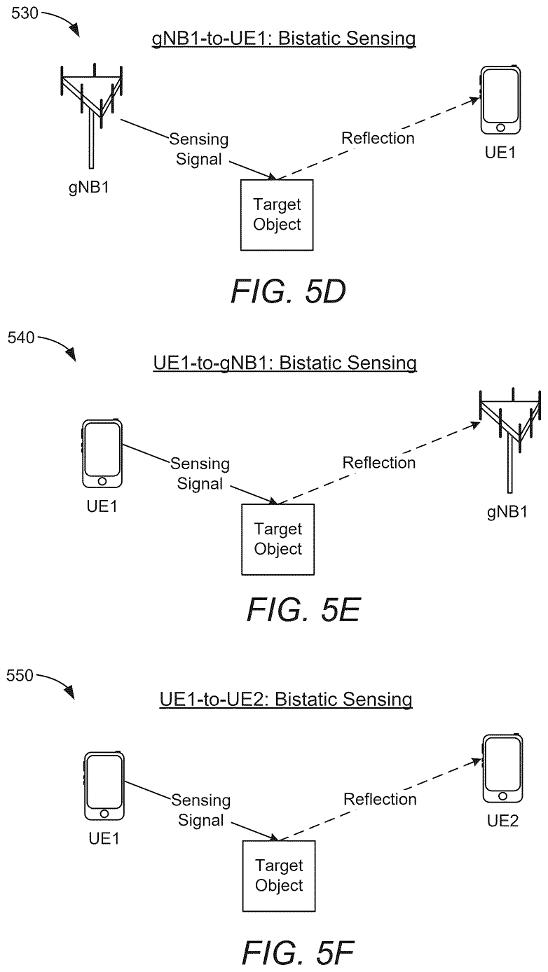

FIGS. 5A to 5F illustrate various example monostatic and bistatic sensing use cases, according to aspects of the disclosure. In FIG. 5A, a gNB1-to-gNB1 monostatic sensing use case 500 is depicted. In FIG. 5B, a UE1-to-UE1 monostatic sensing use case 510 is depicted. In FIG. 5C, a gNB1-to-gNB2 bistatic sensing use case 520 is depicted. In FIG. 5D, a gNB1-to-UE1 bistatic sensing use case 530 is depicted. In FIG. 5E, a UE1-to-gNB1 bistatic sensing use case 540 is depicted. In FIG. 5F, a UE1-to-UE2 bistatic sensing use case 550 is depicted.

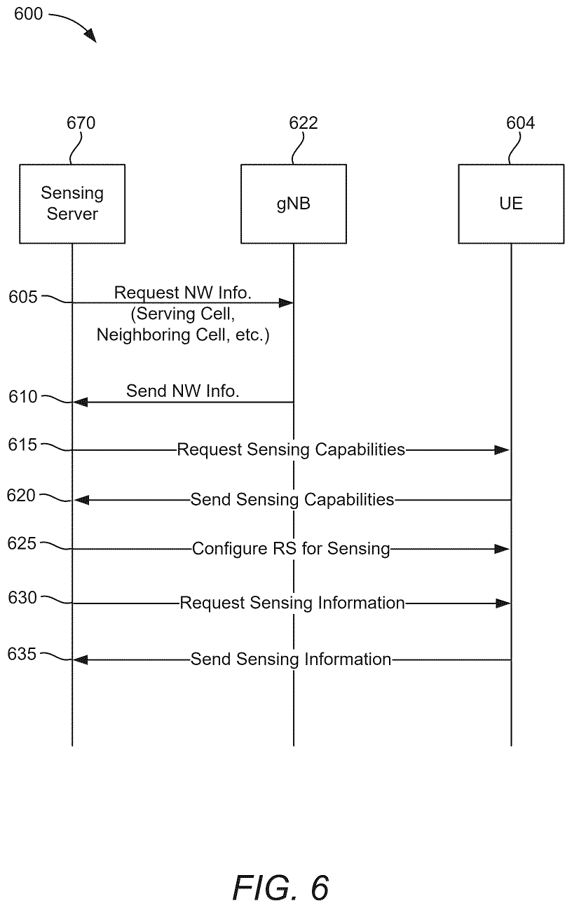

FIG. 6 illustrates an example call flow 600 for an NR-based sensing procedure (e.g., a bistatic sensing procedure) in which the network configures the sensing parameters, according to aspects of the disclosure. Although FIG. 6 illustrates a network-coordinated sensing procedure, the sensing procedure could be coordinated over sidelink channels.

At stage 605, a sensing server 670 (e.g., inside or outside the core network) sends a request for network (NW) information to a gNB 622 (e.g., the serving gNB of a UE 604). The request may be for a list of the UE's 604 serving cell and any neighboring cells. At stage 610, the gNB 622 sends the requested information to the sensing server 670. At stage 615, the sensing server 670 sends a request for sensing capabilities to the UE 604. At stage 620, the UE 604 provides its sensing capabilities to the sensing server 670.

At stage 625, the sensing server 670 sends a configuration to the UE 604 indicating one or more reference signal (RS) resources that will be transmitted for sensing. The reference signal resources may be transmitted by the serving and/or neighboring cells identified at stage 610. In some cases, the NR-based sensing procedure illustrated in FIG. 6 may be a sensing-only procedure or a joint communication and sensing (JCS) procedure. In the case of a sensing-only procedure, the reference signal resources may be reference signal resources specifically configured for sensing purposes. In the case of a JCS procedure, the reference signal resources may be reference signal resources for communication that can also be used for sensing purposes. Alternatively, the reference signal resources for sensing may be multiplexed (e.g., time-division multiplexed) with reference signal resources for communication. For example, the reference signal resources for communication may be an orthogonal frequency division multiplexing (OFDM) waveform, while the reference signal resources for sensing may be a frequency modulation continuous wave (FMCW) waveform.

At stage 630, the sensing server 670 sends a request for sensing information to the UE 604. The UE 604 then measures the transmitted reference signals and, at stage 635, sends the measurements, or any sensing results determined from the measurements, to the sensing server 670.

In an aspect, the communication between the UE 604 and the sensing server 670 may be via the LTE positioning protocol (LPP). The communication between the sensing server 670 and the gNB may be via NR positioning protocol type A (NRPPa).

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

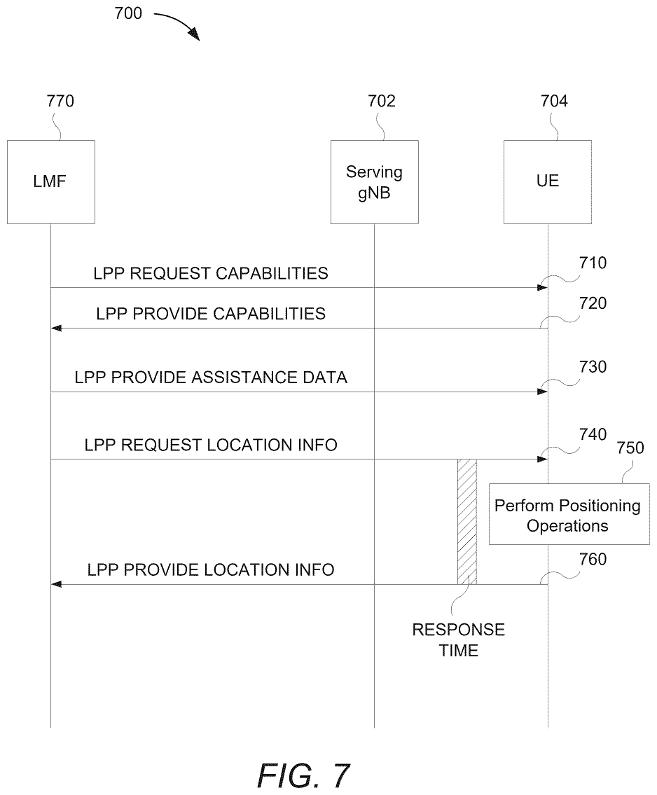

FIG. 7 illustrates an example Long-Term Evolution (LTE) positioning protocol (LPP) procedure 700 between a UE 704 and a location server (illustrated as a location management function (LMF) 770) for performing positioning operations. As illustrated in FIG. 7, positioning of the UE 704 is supported via an exchange of LPP messages between the UE 704 and the LMF 770. The LPP messages may be exchanged between UE 704 and the LMF 770 via the UE's 704 serving base station (illustrated as a serving gNB 702) and a core network (not shown). The LPP procedure 700 may be used to position the UE 704 in order to support various location-related services, such as navigation for UE 704 (or for the user of UE 704), or for routing, or for provision of an accurate location to a public safety answering point (PSAP) in association with an emergency call from UE 704 to a PSAP, or for some other reason. The LPP procedure 700 may also be referred to as a positioning session, and there may be multiple positioning sessions for different types of positioning methods (e.g., downlink time difference of arrival (DL-TDOA), round-trip-time (RTT), enhanced cell identity (E-CID), etc.).

Initially, the UE 704 may receive a request for its positioning capabilities from the LMF 770 at stage 710 (e.g., an LPP Request Capabilities message). At stage 720, the UE 704 provides its positioning capabilities to the LMF 770 relative to the LPP protocol by sending an LPP Provide Capabilities message to LMF 770 indicating the position methods and features of these position methods that are supported by the UE 704 using LPP. The capabilities indicated in the LPP Provide Capabilities message may, in some aspects, indicate the type of positioning the UE 704 supports (e.g., DL-TDOA, RTT, E-CID, etc.) and may indicate the capabilities of the UE 704 to support those types of positioning.

Upon reception of the LPP Provide Capabilities message, at stage 720, the LMF 770 determines to use a particular type of positioning method (e.g., DL-TDOA, RTT, E-CID, etc.) based on the indicated type(s) of positioning the UE 704 supports and determines a set of one or more transmission-reception points (TRPs) from which the UE 704 is to measure downlink positioning reference signals or towards which the UE 704 is to transmit uplink positioning reference signals. At stage 730, the LMF 770 sends an LPP Provide Assistance Data message to the UE 704 identifying the set of TRPs.

In some implementations, the LPP Provide Assistance Data message at stage 730 may be sent by the LMF 770 to the UE 704 in response to an LPP Request Assistance Data message sent by the UE 704 to the LMF 770 (not shown in FIG. 7). An LPP Request Assistance Data message may include an identifier of the UE's 704 serving TRP and a request for the positioning reference signal (PRS) configuration of neighboring TRPs.

At stage 740, the LMF 770 sends a request for location information to the UE 704. The request may be an LPP Request Location Information message. This message usually includes information elements defining the location information type, desired accuracy of the location estimate, and response time (i.e., desired latency). Note that a low latency requirement allows for a longer response time while a high latency requirement requires a shorter response time. However, a long response time is referred to as high latency and a short response time is referred to as low latency.

Note that in some implementations, the LPP Provide Assistance Data message sent at stage 730 may be sent after the LPP Request Location Information message at 740 if, for example, the UE 704 sends a request for assistance data to LMF 770 (e.g., in an LPP Request Assistance Data message, not shown in FIG. 7) after receiving the request for location information at stage 740.

At stage 750, the UE 704 utilizes the assistance information received at stage 730 and any additional data (e.g., a desired location accuracy or a maximum response time) received at stage 740 to perform positioning operations (e.g., measurements of DL-PRS, transmission of UL-PRS, etc.) for the selected positioning method.

At stage 760, the UE 704 may send an LPP Provide Location Information message to the LMF 770 conveying the results of any measurements that were obtained at stage 750 (e.g., time of arrival (ToA), reference signal time difference (RSTD), reception-to-transmission (Rx-Tx), etc.) and before or when any maximum response time has expired (e.g., a maximum response time provided by the LMF 770 at stage 740). The LPP Provide Location Information message at stage 760 may also include the time (or times) at which the positioning measurements were obtained and the identity of the TRP(s) from which the positioning measurements were obtained. Note that the time between the request for location information at 740 and the response at 760 is the “response time” and indicates the latency of the positioning session.

The LMF 770 computes an estimated location of the UE 704 using the appropriate positioning techniques (e.g., DL-TDOA, RTT, E-CID, etc.) based, at least in part, on measurements received in the LPP Provide Location Information message at stage 760.

Machine learning may be used to generate models that may be used to facilitate various aspects associated with processing of data. One specific application of machine learning relates to generation of measurement models for processing of reference signals for positioning (e.g., positioning reference signal (PRS)), such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

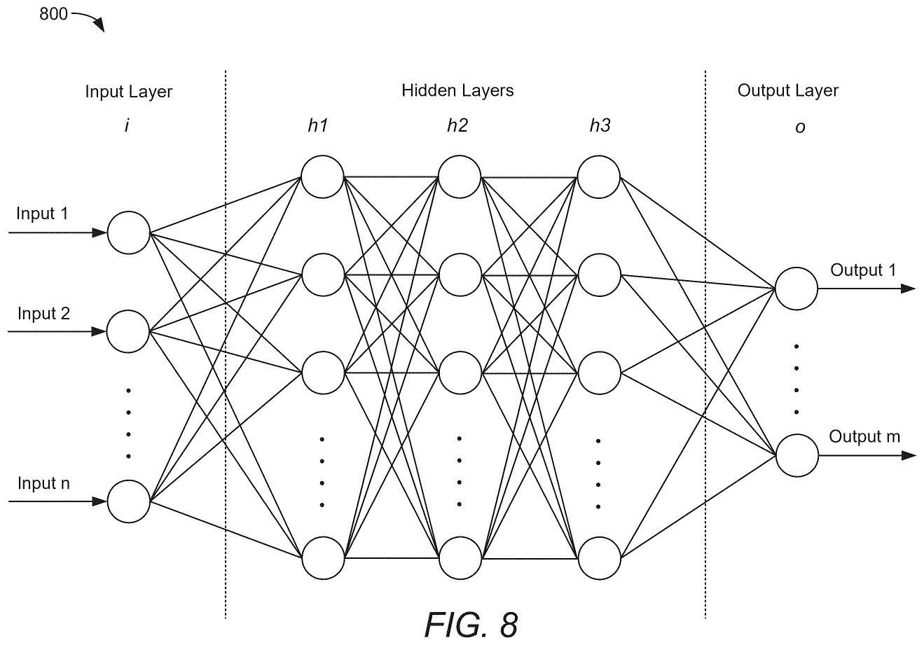

FIG. 8 illustrates an example neural network 800, according to aspects of the disclosure. The neural network 800 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense, PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

The artificial intelligence/machine learning (AIML) positioning and/or sensing provided by an AIML model may be “direct” AIML (denoted “D-AIML”) positioning and/or sensing or AIML “assisted” (denoted “A-AIML”) positioning and/or sensing. Note that, as used herein, an AIML model (whether an A-AIML model or a D-AIML model) may alternatively be referred to as an “ML model,” an “AI model,” an “ML-based model,” an “AI-based model,” and the like.

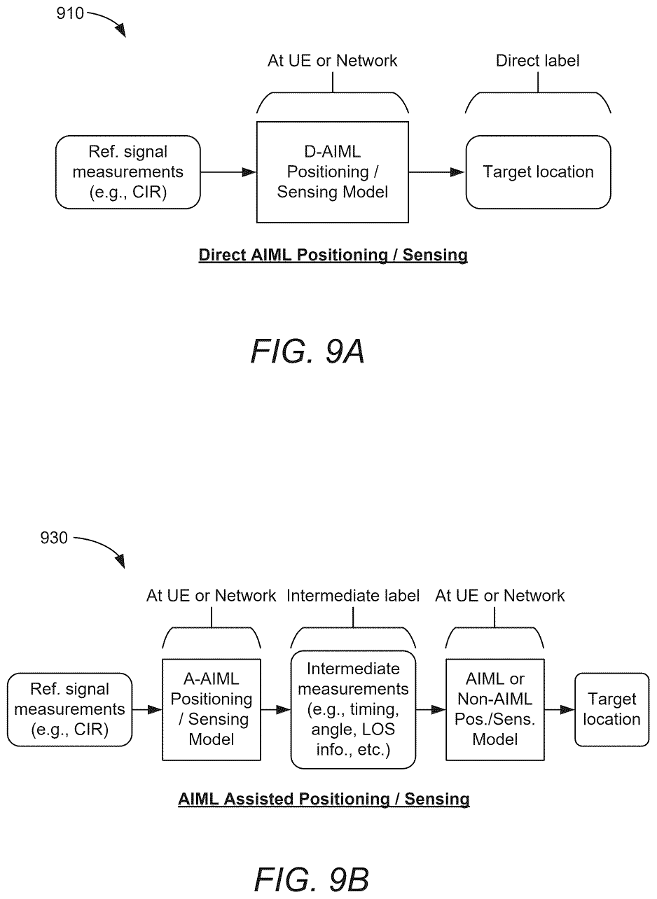

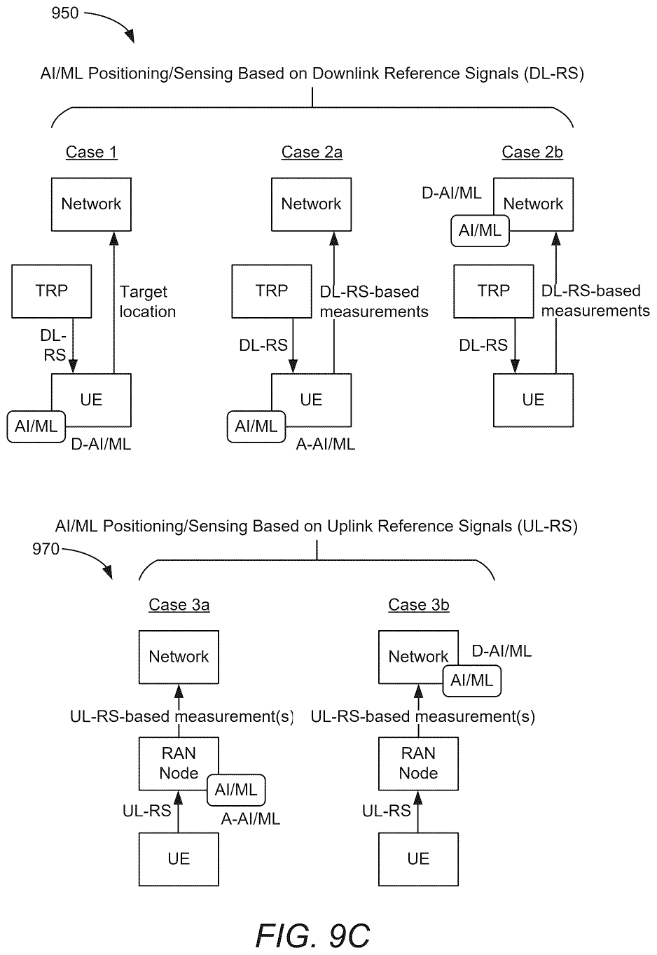

FIG. 9A is a diagram 910 illustrating an example of direct AIML positioning and/or sensing, according to aspects of the disclosure. As shown in FIG. 9A, direct AIML positioning and/or sensing is where the AIML model is trained to accept input features (e.g., downlink positioning reference signal (DL-PRS) measurements, sounding reference signal (SRS) measurements, sidelink positioning reference signal (SL-PRS) measurements, sensing signal measurements, beam measurements (e.g., synchronization signal block (SSB) measurements), channel state information reference signal (CSI-RS) measurements, etc.) and output a final result (referred to as a “direct label”), such as a target location (e.g., a UE location for positioning or a target object location for sensing). The measurements of the reference signal(s) may include the channel energy response (CER), channel impulse response (CIR), power delay profile (PDP), delay profile (DP), channel frequency response (CFR), received signal strength indicator (RSSI), reference signal received power (RSRP), path RSRP (RSRPP), reference signal received quality (RSRQ), time of arrival (ToA), relative ToA (RTOA), reference signal time difference (RSTD), angle of departure (AoD), angle of arrival (AoA), and/or the like of the reference signal(s).

FIG. 9B is a diagram 930 illustrating an example of AIML assisted positioning and/or sensing, according to aspects of the disclosure. As shown in FIG. 9B, AIML assisted positioning and/or sensing is where an AIML model is trained to accept input features (e.g., DL-PRS measurements, SRS measurements, SL-PRS measurements, sensing signal measurements, beam measurements, CSI-RS measurements, etc.) and output one or more intermediate results (also referred to as “intermediate label(s)”). In a positioning context, generating the intermediate result may be referred to as “positioning feature extraction,” which may include determining timing/angle information, line of sight (LOS) identification, etc. The intermediate results may include the ToA, RTOA, RSTD, AOD, AoA, LOS indication, and/or the like. The intermediate result(s) may in turn be provided as an input to another AIML model or non-AIML model positioning and/or sensing technique (e.g., Chan's algorithm, Kalman filtering, etc.) to determine a target location (e.g., a UE location for positioning or a target object location for sensing).

Note that as shown in FIG. 9B, the A-AIML model and the other model/technique may be implemented at the same entity (e.g., UE, base station, location server, sensing server, etc.) or at different entities. For example, for network-assisted positioning, the UE may apply the A-AIML model to compress the measurement data and then report the compressed data to the location server, which may then apply the other position estimation model/technique. As another example, for UE-based positioning, a network component (e.g., a base station, location server, or another UE for sidelink positioning) may apply the A-AIML model to compress the measurement data and report the compressed data to the UE, which then applies the other position estimation model/technique.

FIG. 9C illustrates various AIML positioning and/or sensing scenarios, according to aspects of the disclosure. As shown in diagram 950, there are three AIML positioning and/or sensing deployment scenarios based on downlink reference signals (e.g., DL-PRS, CSI-RS, etc.). The first deployment scenario (labeled “Case 1”) is a UE-based positioning and/or sensing case with a UE-side D-AIML positioning and/or sensing model (labeled “D-AIML”). In this case, the UE applies the D-AIML positioning and/or sensing model (or simply “D-AIML model”) to the downlink reference signal measurements to determine a location of the UE or a target object and reports the target location to the network (e.g., LMF 270).

The second deployment scenario (labeled “Case 2a”) is UE-assisted/network-based positioning and/or sensing with a UE-side A-AIML positioning and/or sensing model that provides AIML-assisted positioning and/or sensing. That is, the UE inputs measurements of downlink reference signals (e.g., DL-PRS, CSI-RS) received from one or more TRPs into the A-AIML positioning and/or sensing model to obtain intermediate measurements (or quantities) of the downlink reference signals. The UE then reports the intermediate measurements to the network (e.g., LMF 270). The network entity may then apply an AIML model or a non-AIML model technique to the intermediate measurements to determine a target location (e.g., of the UE for positioning scenarios or a target object for sensing scenarios).

The third deployment scenario (labeled “Case 2b”) is UE-assisted/network-based positioning and/or sensing scenario with a network-side D-AIML positioning and/or sensing model. That is, the UE reports the measurements of the downlink reference signals received from one or more TRPs to the network (e.g., LMF 270). The network then applies the D-AIML positioning and/or sensing model to the measurements to determine the location of the UE or a target object.

As shown in diagram 970, there are two AIML positioning and/or sensing deployment scenarios based on uplink reference signals (e.g., SRS). The first deployment scenario (labeled “Case 3a”) is RAN node-assisted positioning and/or sensing with a RAN-side AIML model that provides AIML assisted positioning and/or sensing. In this case, the RAN node (e.g., a base station, TRP, or other base station component) applies an A-AIML positioning and/or sensing model to TRP measurements of one or more uplink reference signals (e.g., SRS) transmitted by a UE to obtain intermediate measurements of the received uplink reference signal(s). The RAN node then reports the intermediate measurements to the core network (e.g., LMF 270), which can use them to locate the UE (for positioning) or a target object (for sensing).

The second deployment scenario (labeled “Case 3b”) is RAN node-assisted positioning and/or sensing with a network-side AIML positioning and/or sensing model that provides direct AIML positioning and/or sensing. In this case, the RAN node reports measurements of one or more uplink reference signals received from a UE to the core network (e.g., LMF 270). The core network then applies a D-AIML positioning and/or sensing model to the measurements of the uplink reference signal(s) to obtain a target location of the UE (for positioning) or a target object (for sensing).

Note that there may be other deployment scenarios in which the UE, RAN, or the core network use an AIML positioning and/or sensing model to compute or report a positioning and/or sensing estimate (target location), but these cases are implementation-specific and do not necessarily involve signaling between the UE, RAN, and/or the core network.

Further note that an AIML model may execute in a training mode or an inferencing mode. In the training mode, the AIML model is provided with pre-validated input data along with pre-validated output data to derive or modify weights of the AIML to increase the reliability of the AIML model to provide new (unvalidated) output data that is similar to the pre-validated output data in response to new (unvalidated) input data that is similar to the pre-validated input data. In the inferencing mode, the AIML model utilizes the weights determined during the training mode to process new (unvalidated) input data so as to generate new (unvalidated) output data (typically, without further adjusting the weights until/unless the AIML model returns to the training mode). The (unvalidated) output data may be characterized as an “inference.” Thus, the “final” positioning or sensing results described above with respect to FIGS. 9A to 9C may correspond to AIML model weights or inferences depending on whether the respective AIML model is executing in the training mode or the inferencing mode.

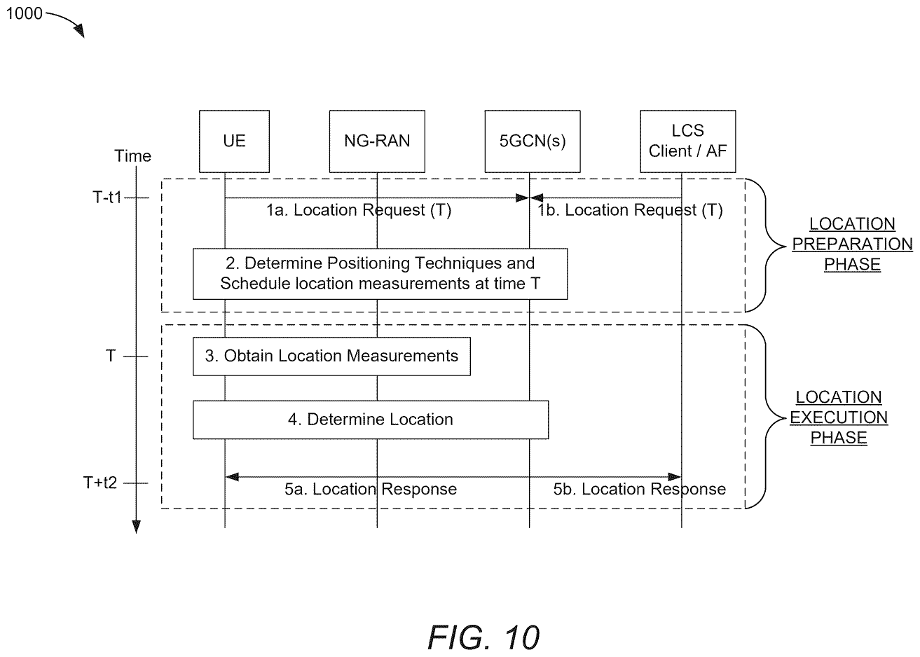

FIG. 10 illustrates a “scheduled location time” position estimation session in accordance with aspects of the disclosure.

Referring to FIG. 10, in addition to “on-demand” position estimation sessions (i.e., position estimation sessions which attempt to return a location response as soon as possible), 3GPP also supports “scheduled location time” position estimation sessions, which allows for an LCS Client (or application function (AF)) to specify a time T in the future at which a current location of the UE is to be obtained. The “scheduled location time” position estimation session 1000 of FIG. 10 is split into two phases: a location preparation phase and a location execution phase. At 1a or 1b, at time T−t1, the location preparation phase starts when a location related request is sent by an LCS Client, AF or UE requesting a location of the UE at future time T. At 2, at or near to time T, the UE, NG-RAN and/or 5G core network (5GCN) determines positioning techniques (e.g., multi-RTT, AoA/AOD, TDOA, etc.) and scheduled location measurements accordingly for the position estimation session. At 3, the location execution phase starts at or near to the time T with the NG-RAN and/or UE obtaining the location measurements that were scheduled during the location preparation phase. At 4, LCS Client, AF or UE determine the position estimate of the UE. At 5a or 5b, at time t+t2, the location request returns a location response including the position estimate of the UE (i.e., sent to an LCS Client, AF or UE).

Referring to FIG. 10, latency observed by the client is the latency of the execution phase. In an aspect, UE location at time T roughly corresponds UE location at Time T+t2. In an aspect, the duration of the location preparation phase (t1 in FIG. 10) is not included in the overall location response time. Instead, the location response time equals the duration of the location execution phase (t2 in FIG. 10) which may be used to reduce latency.

Referring to FIG. 10, in some designs, use of a scheduled location time allows latency to be reduced since effective latency only commences at the scheduled location time and can exclude time spent prior to this for sending the location request and scheduling the location measurements.

Referring to FIG. 10, in some designs, a scheduled location time allows an external LCS Client, AF or the UE to specify a time in the future at which a current location of the UE is to be obtained. In an aspect, a scheduled location time can be used with a 5GC-MT-LR, 5GC-MO-LR or deferred 5GC-MT-LR for periodic or triggered location events. In an aspect, location preparation phase starts when a location related request is sent by an LCS Client, AF or UE requesting a current location of the UE. In an aspect, request includes the scheduled location time T. In an aspect, as part of the location preparation phase, the 5GC, and UE interact to determine suitable position methods and schedule location measurements of the UE. In an aspect, the LMF coordinates the interaction and is aware of the scheduled location time. In an aspect, the location preparation phase ends at or near to the time T and is followed by a location execution phase in which the UE location is obtained and returned to the external LCS Client, AF or the UE. In an aspect, scheduled location time only applies when an external LCS Client, AF or the UE is aware of a specific time in the future at which the location of the UE is needed. In an aspect, location estimate returned to an LCS Client, AF or UE for a scheduled location time can be treated by the LCS Client, AF or UE as an estimate of the location of the UE at the scheduled location time. In an aspect, to support the Scheduled Location Time in 5GC-MO-LR, the UE defers sending the request to AMF until the time remaining until the scheduled location time is within some implementation dependent threshold in order to avoid failure triggered by HTTP request timeout. In an aspect, when support the Scheduled Location Time in 5GC-MT-LR (i.e. the LCS Client/AF obtains one time UE location at Scheduled Location Time), to avoid failure triggered by HTTP request timeout, one of the following methods is applied: the LCS Client or AF defers sending the request until the time remaining until the scheduled location time is within some implementation dependent threshold; or re-using the deferred 5GC-MT-LR for periodic location events procedure to realize providing one time UE location at Scheduled Location Time by, e.g. set the value of total reporting number parameter in the location request to one.

Referring to FIG. 10, in some designs, the scheduled location time T can be included in the LPP Request Location Information message sent to the target device. In an aspect, assistance data, capability, measurement gap, etc. signaling occurs before T (“Location Preparation Phase”). In an aspect, the UE performs measurements/location estimate at or around T (to be valid for time T). In an aspect, the IE ScheduledLocationRequest may be included in the ID CommonIEsRequestLocationInformation.

In some designs, the LMF may provide a UE with a description of the multipath in the current UE area, using the “Environment” field which provides coarse radio frequency (RF) environment information, e.g.:
CommonIEsRequestLocationInformation

The CommonIEsRequestLocationInformation carries common IEs for a Request Location Information LPP message Type.

| -- ASN1START | |
|---|---|
| CommonIEsRequestLocationInformation ::= SEQUENCE { | |
| environment Environment | OPTIONAL, -- Need ON |

...

TABLE 1
CommonIEsRequestLocationInformation field descriptions

environment
This field provides the target device with information about expected multipath and non line of
sight (NLOS) in the current area. The following values are defined:

| | | |
|---|---|---|
| - | badArea: | possibly heavy multipath and NLOS conditions (e.g. bad urban or urban). |
| - | notBadArea: | no or light multipath and usually LOS conditions (e.g. suburban or rural). |
| - | mixedArea: | environment that is mixed or not defined. |

If this field is absent, a default value of ‘mixedArea’ applies.

In some designs, using the “Environment” information, the user equipment (UE) may adequately adapt its processing techniques to match the characteristics of the propagation environment. However, the information obtained from the location management function (LMF) is very coarse. Additionally, in some designs, the information may be not accurate or may be stale, as the LMF is not expected to have appropriate means to assess the environment of the UE area.

Aspects of the disclosure are directed to signaling of environment information from a sensing component. In an aspect, the sensing component may correspond to a sensing server (or sensing management function (SnMF)) or a sensing node (e.g., a wireless node capable of receiving and measuring sensing signals for monostatic sensing or bistatic sensing). In an aspect, utilizing environment information from a sensing component (e.g., as opposed to coarse radio frequency (RF) environment information which is tracked by a location management function (LMF)) may facilitate various technical advantages, such as improving sensing and/or position estimation accuracy and/or reducing sensing and/or position estimation latency, improving beam management procedure(s) and/or a channel state information (CSI) procedure(s), and so on.

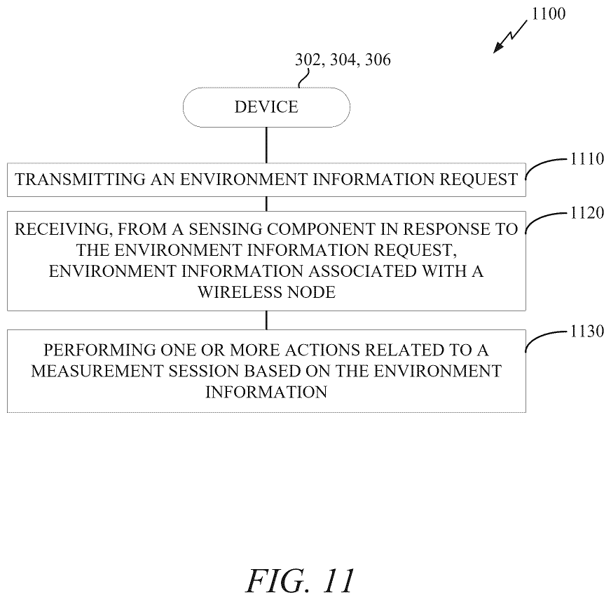

FIG. 11 illustrates an exemplary process 1100 of communications according to an aspect of the disclosure. The process 1100 of FIG. 11 is performed by a device. In some designs, the device may correspond to a wireless network component (e.g., gNB/BS/TRP 304 or O-RAN component such as RU) or other network component (e.g., a remote location server (e.g., LMF) or sensing server (e.g., SnMF) such as network entity 306, etc.). In other designs, the device may correspond to a UE (e.g., sidelink anchor UE or sidelink server UE or target UE). In scenarios where the device is integrated with another device (e.g., UE, gNB/BS/TRP, LMF, SnMF, etc.), reference to any Rx/Tx operations between the device and the other device in which the device is integrated may correspond to transfer of information between different logical components of the device over a data bus, etc.

Referring to FIG. 11, at 1110, the device (e.g., transmitter 314 or 324 or 354 or 364, network transceiver(s) 380 or 390, data bus 308 or 382 or 392, etc.) transmits an environment information request. In some designs, a means for performing the transmission of 1110 includes transmitter 314 or 324 or 354 or 364, network transceiver(s) 380 or 390, data bus 308 or 382 or 392, etc., of FIGS. 3A-3C.

Referring to FIG. 11, at 1120, the device (e.g., receiver 312 or 322 or 352 or 362, network transceiver(s) 380 or 390, data bus 308 or 382 or 392, etc.) receives, from a sensing component in response to the environment information request, environment information associated with a wireless node. In some designs, a means for performing the reception of 1120 includes receiver 312 or 322 or 352 or 362, network transceiver(s) 380 or 390, data bus 308 or 382 or 392, etc., of FIGS. 3A-3C.

Referring to FIG. 11, at 1130, the device (e.g., receiver 312 or 322 or 352 or 362, transmitter 314 or 324 or 354 or 364, network transceiver(s) 380 or 390, data bus 308 or 382 or 392, etc.) performs one or more actions related to a measurement session based on the environment information. In some designs, a means for performing the action(s) of 1130 includes receiver 312 or 322 or 352 or 362, transmitter 314 or 324 or 354 or 364, network transceiver(s) 380 or 390, data bus 308 or 382 or 392, etc., of FIGS. 3A-3C.

Referring to FIG. 11, in some designs, the wireless node corresponds to a user equipment (UE) or a wireless network component.

Referring to FIG. 11, in some designs, the device corresponds to the wireless node, a user equipment (UE), a wireless network component, a position estimation entity, a location management function (LMF), a location server, or a combination thereof.

Referring to FIG. 11, in some designs, the sensing component corresponds to a sensing management component associated with a first network corresponding to a first radio access technology (RAT), or the sensing component corresponds to a sensing node associated with a second network corresponding to a second RAT that is different than the first RAT.

Referring to FIG. 11, in some designs, the environment information request is transmitted to the sensing component, or the environment information request is transmitted to a sensing management component that is separate from the sensing component, or the environment information request is transmitted to a network component that is separate from the sensing component and the sensing management component.

Referring to FIG. 11, in some designs, the environment information request comprises, e.g.: an area of interest indication, or a scheduled environment information time, or any combination thereof.

Referring to FIG. 11, in some designs, the device further receives an indication of capability information of the sensing component. In an aspect, the environment information request is based on the capability information. In an aspect, the capability information comprises a capability of the device to perform on-demand environment measurements. In an aspect, the indication of the capability information is signaled via a sensing system information block (SIB), or the indication of the capability information is signaled via dedicated signaling.

Referring to FIG. 11, in some designs, some or all of the environment information is obtained by the sensing component before the environment information request is transmitted, or some or all of the environment information is obtained by the sensing component via one or more measurement procedures performed in response to the environment information request, or a combination thereof.

Referring to FIG. 11, in some designs, the environment information comprises, e.g.:
tracking object size information, or
tracking object motion information, or
tracking object type information, or
reconfigurable intelligence surface (RIS) information, or
channel environment information, or
an indication of one of a plurality of channel environment quality tiers, or
line of sight (LOS) information or non-LOS (NLOS) information, or
delay spread information, or
angular spread information, or
multipath information, or
location profile information, or
an indication that one or more environment information types are unavailable, or
a reason why the one or more environment information types are unavailable, or
any combination thereof.

Referring to FIG. 11, in some designs, the environment information is wireless node-specific.

Referring to FIG. 11, in some designs, the measurement session comprises, e.g.:
a position estimation session of a user equipment (UE), or
a beam management procedure, or
a channel state information (CSI) procedure, or
a sensing session of one or more target objects, or
any combination thereof.

Referring to FIG. 11, in some designs, the one or more actions comprises, e.g.:
performing one or more transmissions of one or more first reference signals for positioning (RF-Ps), or
performing one or more measurements of one or more second RF-Ps, or
selecting an artificial intelligence machine learning model (AIML) model for positioning for generation of one or more inferences based on the one or more measurements, or
selecting an AIML model for sensing for generation of at least one inference based on the one or more measurements, or
any combination thereof.

Referring to FIG. 11, in some designs, the device further transmits, in response to the environment information, an environment information availability message, receives, in response to the environment information availability message, a request for some or all of the environment information, and transmits, in response to the request, the requested environment information.

Referring to FIG. 11, in some designs, the device further transmits the indication of the set of sensing components is received in response to the environment information request.

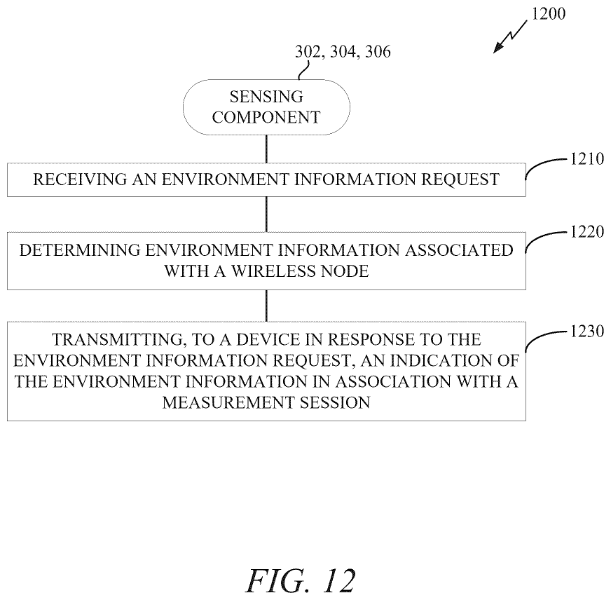

FIG. 12 illustrates an exemplary process 1200 of communications according to an aspect of the disclosure. The process 1200 of FIG. 120 is performed by a sensing component. In some designs, the sensing component corresponds to a sensing node that is capable of performing a radio frequency (RF) sensing receive operation (e.g., a monostatic or bistatic RF sensing receive operation), such as a UE (e.g., UE 302) or a wireless network component such as gNB/BS/TRP 304 or O-RAN component such as RU. In other designs, the sensing component corresponds to a sensing management component, such as a sensing server (e.g., network entity 306) or a sensing management function (SnMF). In scenarios where the sensing component is integrated with another device (e.g., UE, gNB/BS/TRP, LMF, SnMF, etc.), reference to any Rx/Tx operations between the sensing component and the other device in which the sensing component is integrated may correspond to transfer of information between different logical components of the device over a data bus, etc.

Referring to FIG. 12, at 1210, the sensing component (e.g., receiver 312 or 322 or 352 or 362, network transceiver(s) 380 or 390, data bus 308 or 382 or 392, etc.) receives an environment information request. In some designs, a means for performing the reception of 1210 includes receiver 312 or 322 or 352 or 362, network transceiver(s) 380 or 390, data bus 308 or 382 or 392, etc., of FIGS. 3A-3C.

Referring to FIG. 12, at 1220, the sensing component (e.g., processor(s) 342 or 384 or 394, environment information component 348, receiver 312 or 322 or 352 or 362, network transceiver(s) 380 or 390, data bus 308 or 382 or 392, etc.) determines environment information associated wireless node. In some designs, a means for performing the determination of 1220 includes processor(s) 342 or 384 or 394, environment information component 348, receiver 312 or 322 or 352 or 362, network transceiver(s) 380 or 390, data bus 308 or 382 or 392, etc., of FIGS. 3A-3C.

Referring to FIG. 12, at 1230, the sensing component (e.g., transmitter 314 or 324 or 354 or 364, network transceiver(s) 380 or 390, data bus 308 or 382 or 392, etc.) transmits, to a device in response to the environment information request, an indication of the environment information in association with a measurement session. In some designs, a means for performing the transmission of 1230 includes transmitter 314 or 324 or 354 or 364, network transceiver(s) 380 or 390, data bus 308 or 382 or 392, etc., of FIGS. 3A-3C.

Referring to FIG. 12, in some designs, the environment information is obtained before the environment information request is received, or the environment information is obtained in response to the environment information request.

Referring to FIG. 12, in some designs, the environment information request is received from a sensing management component associated with a first network corresponding to a first radio access technology (RAT), and the sensing component corresponds to a sensing node associated with a second network corresponding to a second RAT that is different than the first RAT.

Referring to FIG. 12, in some designs, the sensing component corresponds a sensing management component associated with a first network corresponding to a first radio access technology (RAT). In an aspect, the sensing component further transmits, to at least one sensing node associated with a second network corresponding to a second RAT that is different than the first RAT, a sensing session request, and receives, from the at least one sensing node, the environment information in response to the sensing session request. In an aspect, the at least one sensing node comprises multiple sensing nodes, and the environment information transmitted to the device is aggregated from the environment information received from each of the multiple sensing nodes.

Referring to FIG. 12, in some designs, the wireless node corresponds to a user equipment (UE) or a wireless network component.

Referring to FIG. 12, in some designs, the device corresponds to the wireless node, a user equipment (UE), a wireless network component, a position estimation entity, a location management function (LMF), a location server, or a combination thereof.

Referring to FIG. 12, in some designs, the environment information request comprises, e.g.: an area of interest indication, or a scheduled environment information time, or any combination thereof.

Referring to FIG. 12, in some designs, the sensing component further transmits an indication of capability information of the sensing component. In an aspect, the environment information request is based on the capability information. In an aspect, the capability information comprises a capability of the device to perform on-demand environment measurements. In an aspect, the indication of the capability information is signaled via a sensing system information block (SIB), or the indication of the capability information is signaled via dedicated signaling.

Referring to FIG. 12, in some designs, the environment information comprises, e.g.:
tracking object size information, or
tracking object motion information, or
tracking object type information, or
reconfigurable intelligence surface (RIS) information, or
channel environment information, or
an indication of one of a plurality of channel environment quality tiers, or
line of sight (LOS) information or non-LOS (NLOS) information, or
delay spread information, or
angular spread information, or
multipath information, or
location profile information, or
an indication that one or more environment information types are unavailable, or
a reason why the one or more environment information types are unavailable, or
any combination thereof.

Referring to FIG. 12, in some designs, the environment information is wireless node-specific.

Referring to FIG. 12, in some designs, the measurement session comprises, e.g.:
a position estimation session of a user equipment (UE), or
a beam management procedure, or
a channel state information (CSI) procedure, or
a sensing session of one or more target objects, or
any combination thereof.

Referring to FIGS. 11-12, in a specific example, the LMF requests the SnMF to provide environment characterization. In an aspect, the request includes an area of interest. In an aspect, the request could include scheduled time, at which the environment characterization is desired. As noted above, the scheduled time parameter is known in a positioning context with respect to the scheduled-location time location request, where a location client requests a UE location at a specific desired time.

Referring to FIGS. 11-12, in a specific example, the SnMF response to the LMF may include characterization of the environment that contains an indication of one of the pre-defined options defined for the LMF, e.g.:

```
Environment :: = ENUMERATED {
  badArea,
  notBadArea,
  mixedArea,
  ...
}
```

Referring to FIGS. 11-12, in a specific example, the SnMF response to the LMF may include characterization of the environment that provides an enhanced granular multipath characterization. In an aspect, the field options used to describe the environment could be enhanced and the SnMF selects the value best matching the environment, e.g.:

```
Environment :: = ENUMERATED {
  badArea,
  ClearLOS,
  LOSwithRicianFactor10dB,
  LOSwithRicianFactor0dB,
  LOSwithRician-10dB,
  FullNLOS,
  ...
}
```

In an aspect, the granularity in the above-noted example is based the LOS condition. In other aspects, there could be characterization described as a function of other channel characteristics, such as expected delay spread, angular spread, and so on.

Referring to FIGS. 11-12, in a specific example, the SnMF response to the LMF may include characterization of the environment that provides a physical characterization of the environment. In an aspect, instead of describing the multipath nature, the SnMF can characterize the environment based on similarity to known reference environments. For example, a new PhysicalEnvironment field may be introduced, e.g.:

```
Environment :: = ENUMERATED {
  Office,
  Hallway,
  Wide Open Space,
  Indoor Factory,
  Indoor Mall,
  Outdoor mall
  ...
}
```

Referring to FIGS. 11-12, in a specific example, the SnMF response to the LMF may include characterization of the environment that provides a combination of multipath characterization and physical characterization.

Referring to FIGS. 11-12, in a specific example, the SnMF response to the LMF may include characterization of the environment that provides an error message with reasons, in the case the SnMF is not able to provide a response to the LMF request.

Referring to FIGS. 11-12, in a specific example, the multipath characterization of the UE environment could be provided on a per-TRP basis.

Referring to FIGS. 11-12, in a specific example, the environment characterization content may be based on the SnMF capabilities/abilities, and/or requested by the LMF. Note that upon receiving the request form the LMF, the SnMF may either, e.g.:
Option 1: have the required environment already available. This could have been the outcome of previous sensing session and the SnMF saves the results of its previous environment characterizations.
Option 2: schedule and coordinate a new sensing session to generate a response to the LMF request.

Referring to FIGS. 11-12, in a specific example, the LMF request to the SnMF could be triggered by the UE Environment characterization request to the LMF. In an aspect, the LMF can signal or broadcast (e.g., in a POS-SIB) its capability of providing Environment characterization on-demand.

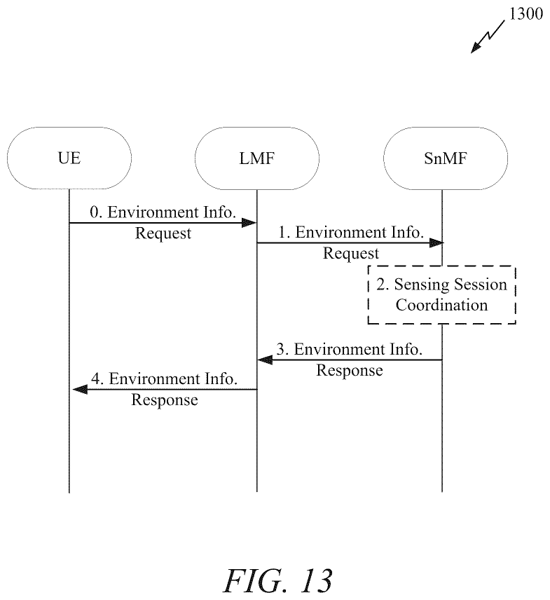

FIG. 13 illustrates an example implementation 1300 of the processes 1100-1200 of FIGS. 11-12, respectively, in accordance with aspects of the disclosure. At (0), the UE transmits an environment request to the LMF. At (1), the LMF transmits an environment request to the SnMF. At (2), the SnMF (optionally) coordinates a sensing session to obtain the requested environment information. In an aspect, the sensing session coordination at (2) is optional because the SnMF may already have the requested environment information, and if so, the sensing session coordination at (2) can be skipped. At (3), the SnMF transmits an environment information response to the LMF that includes the requested environment information. At (4), the LMF transmits an environment information response to the UE that includes the requested environment information. Note that in FIG. 13, the device performing the process 1100 of FIG. 11 may correspond to either the UE or the LMF, and the sensing component performing the process 1200 of FIG. 12 may correspond to either the LMF or the SnMF.

Referring to FIGS. 11-12, in a specific example, the UE may be unaware of the interaction between the LMF the SnMF depicted in FIG. 13. In other words, how the LMF obtains the characterization is transparent to the UE. In this case, the UE behavior is only expected to be able to decode the supported enhanced Environment characterization format, as obtained from the LMF. In an alternative approach/design, the UE can request the environment characterization from the SnMF directly on its own. This may facilitate the UE to obtain the Environment characterization that can be used toward enhancing other use cases beyond the positioning use case (a UE can still request the information for positioning use case).

Referring to FIGS. 11-12, in a specific example, a UE request for Environment characterization from the SnMF may be implemented via UE-to-SnMF dedicated signaling. In an aspect, SnMF-to-UE response contains the Environment characterization via SnMF-to-UE dedicated signaling. In an aspect, the UE request and the SnMF response may otherwise be similar to the LMF-SnMF interaction aspects as depicted in FIG. 13. Note that for direct UE-SnMF interaction, in an aspect, the UE may be made aware of the SnMF capabilities of providing Environment characterization.

Referring to FIGS. 11-12, in a specific example, the SnMF capabilities for Environment characterization may be signaled in a sensing system information block, or provided to the UE on request. In an aspect, a UE request for Environment characterization from the SnMF may be implemented via UE-SnMF dedicated signaling. In an aspect, the SnMF-to-UE response may include the Environment characterization in SnMF-to-UE dedicated signaling. In an aspect, the UE request and the SnMF response may otherwise be similar to the LMF-SnMF interaction aspects as depicted in FIG. 13.

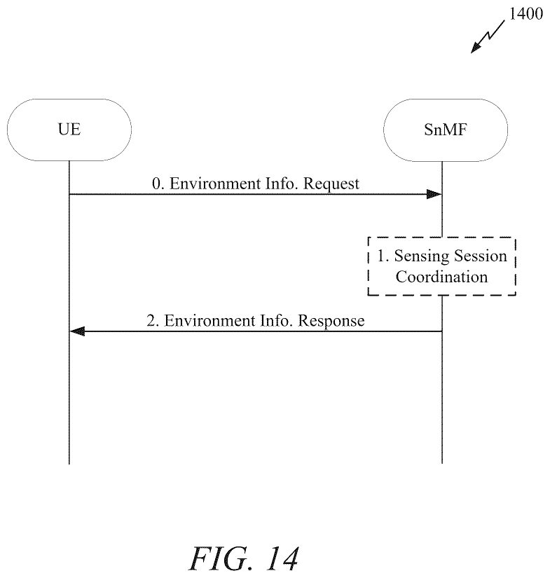

FIG. 14 illustrates an example implementation 1400 of the processes 1100-1200 of FIGS. 11-12, respectively, in accordance with aspects of the disclosure. At (0), the UE transmits an environment request to the SnMF. At (1), the SnMF (optionally) coordinates a sensing session to obtain the requested environment information. In an aspect, the sensing session coordination at (1) is optional because the SnMF may already have the requested environment information, and if so, the sensing session coordination at (1) can be skipped. At (2), the SnMF transmits an environment information response to the UE that includes the requested environment information. Note that in FIG. 14, the device performing the process 1100 of FIG. 11 may correspond to the UE, and the sensing component performing the process 1200 of FIG. 12 may correspond to the SnMF.

Referring to FIGS. 11-12, in a specific example, the UE environment characterization may be used to enhance other use cases beyond the positioning use case. In an aspect, the request about the UE environment characterization may come from the gNB. In an aspect, the gNB may use the Environment to configure UEs according to its environment state. In an aspect, a gNB requests Environment characterization from the SnMF via gNB-to-SnMF dedicated signaling. In an aspect, the SnMF-to-gNB response contains the Environment characterization in SnMF-to-gNB dedicated signaling. In an aspect, the gNB request and the SnMF response may otherwise be similar to the LMF-SnMF interaction aspects as depicted in FIG. 13.

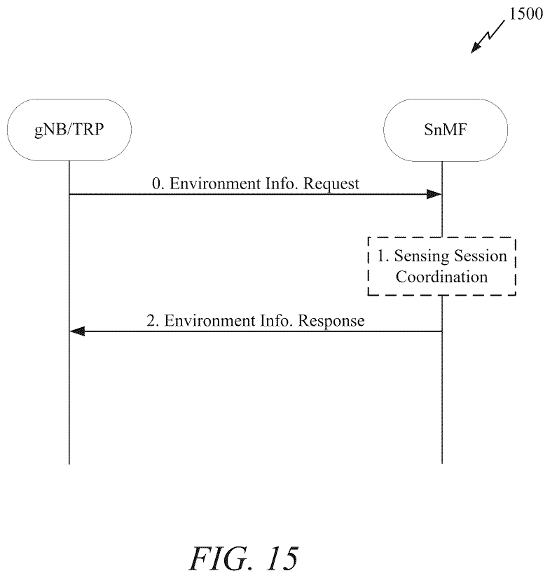

FIG. 15 illustrates an example implementation 1500 of the processes 1100-1200 of FIGS. 11-12, respectively, in accordance with aspects of the disclosure. At (0), the gNB transmits an environment request to the SnMF. At (1), the SnMF (optionally) coordinates a sensing session to obtain the requested environment information. In an aspect, the sensing session coordination at (1) is optional because the SnMF may already have the requested environment information, and if so, the sensing session coordination at (1) can be skipped. At (2), the SnMF transmits an environment information response to the gNB that includes the requested environment information. Note that in FIG. 15, the device performing the process 1100 of FIG. 11 may correspond to the gNB, and the sensing component performing the process 1200 of FIG. 12 may correspond to the SnMF.

Referring to FIGS. 11-12, in a specific example, for many positioning use cases, the UE may seek to accurately estimate the time of arrival. In an aspect, time of arrival is typically estimated using peak detection on the channel impulse response (CIR). However, CIR-based peak detection performance degrades in the presence of multipath which can cause the LOS path to merge with delayed multipath, so that the main peak in the CIR appears delayed, leading to an estimation bias. In an aspect, super-resolution techniques (e.g., MUltiple SIgnal Classification (MUSIC)) have the capability to resolve narrowly spaced multipath components. However, such super-resolution techniques only provide good performance under a correct modeling of the number of multipath components (i.e., multipath order). A wrong assumption on the multipath order degrades the accuracy of super-resolution techniques. In an aspect, the multipath order is a signature of the environment. In an aspect, with enhanced Environment characterization as described above, the UE can more accurately set assumptions on the multipath order, and achieve desired accuracy.

Referring to FIGS. 11-12, in a specific example, 3GPP is considering standardization of the use of AIML techniques for positioning, beam management and CSI prediction use cases. Future release may seek to standardize other wireless use cases such as sensing. One of the challenges for AIML models in the generalization across different environments. Many AIML models are developed to perform well in certain environments, and such AIML models perform poorly if they are used in different environment different than the training environment. In an aspect, with the enhanced characterization of the environment as described above, the UE/network can choose an AIML model that is adapted to the UE environment, leading to enhanced performance.

Referring to FIGS. 11-12, in a specific example, the SnMF may provide environment information including an indication of object(s) to the UE and/or gNB. In an aspect, location of objects, their characteristics/type, their motion status (static/mobile), and so on, may be indicated by the SnMF to the gNB or the UE. In an aspect, the motion information may make the SnMF environment characterization uniquely different as compared to providing a static map. In an aspect, environment “enclosure” information can also be shared like enclosed (e.g., closed room, etc.), semi-enclosed (e.g., balcony, etc.), open (e.g., terrace, garden, etc.).

Referring to FIGS. 11-12, in a specific example, the gNB can use the object-based environment information to beamform the rays, or try to match its channel. In an aspect, the gNB/UE may activate a reconfigurable intelligence surface (RIS) (if available) in case the object(s) detected are of a large size which might be obstructing gNE-UE and/or UE-UE LOS. In an aspect, gNB/UE can use the object-based environment information to confirm multiple parameters/timers accordingly, e.g.:
If a chair, table, monitor, etc., are detected, the environment could be a work space and UE might not be static for long and thus the search (serving/neighbor cells) timer can be longer saving power.
If seats with more people are detected, the environment could be a vehicle which might be moving and the timers can be configured aggressively.
For a customer premises equipment (CPE) device which typically operates indoors and on mmwave, knowing the objects can help the CPE device configure the beams appropriately, configure CSI-RS appropriately especially for beam switching, and/or enable RIS in case some areas are not serviced properly, etc., CPE can perform an initial setup by requesting the object details and their location and can perform this in a periodic manner, aperiodic manner when it senses some change in the channel measurements reported or when CPE has moved.
In extended reality (XR) kind of applications, UE might be XR headset and playing game, attending meeting (like in metaverse), etc., and might be in motion. Indicating the objects, their position can help the user not collide with them and appropriately adjust his/her motion.

Referring to FIGS. 11-12, in a specific example, as mentioned above, the UE environment characterization could be used to enhance other use cases beyond the positioning use case. In a further aspect, the environment could be characterized around a TRP as well, in place of or in addition to UE-centric environment information (e.g., TRP of low height in urban areas, CPE, UAV's carrying small cells flying at a height or inside building/warehouses or especially in remote areas like mountain terrain, forests, etc.). In an aspect, the gNB provides the environment area to be characterized by providing the location of the TRP, or by indicating the area of interest boundaries in 3D dimensions (x,y,z).

Referring to FIGS. 11-12, in a specific example, after receiving the Environment characterization request, the SnMF may determine that the request could be better handled by a nearby access point from a non-3GPP RAT (e.g., Wi-Fi, etc.). In an aspect, the SnMF may request environment information data from Wi-Fi access points (APs). For example, the UE may be inside a shopping center. The network knows which Wi-Fi AP(s) are in the area of the shopping center, and requests a new Environment characterization from the Wi-Fi AP(s). In an aspect, the SnMF-AP signaling could be exchanged over the non-3GPP Interworking Function (N3IWF), which enables interworking function between 3GPP (NR) and non-3GPP. In an aspect, the SnMF could request response from multiple Wi-Fi APs simultaneously, and may aggregate/combine their response. In an aspect, the SnMF forwards the aggregated response to the requesting node (e.g., UE). Note that in this architecture, the requesting node (e.g., UE) may be unaware of the SnMF-AP interactions. Also, in an aspect, the SnMF-AP signaling could be proprietary as well.

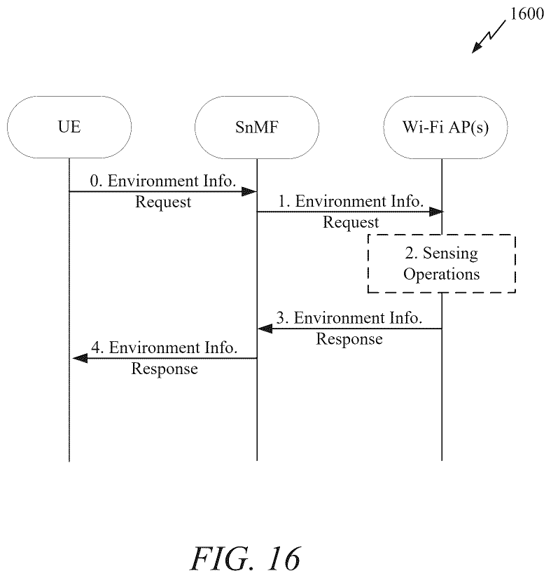

FIG. 16 illustrates an example implementation 1600 of the processes 1100-1200 of FIGS. 11-12, respectively, in accordance with aspects of the disclosure. At (0), the UE transmits an environment request to the SnMF. At (1), the SnMF transmits an environment request to one or more Wi-Fi AP(s). At (2), the Wi-Fi AP(s) (optionally) perform sensing operations to obtain the requested environment information. In an aspect, the sensing operations at (2) are optional because the Wi-Fi AP(s) may already have the requested environment information, and if so, the sensing operations at (2) can be skipped. At (3), the Wi-Fi AP(s) transmits environment information response(s) to the SnMF that includes the requested environment information. At (4), the SnMF transmits environment information response(s) to the UE that includes the requested environment information. As noted above, in an aspect, the environment information response at (4) may aggregate environment information from multiple Wi-Fi APs. Note that in FIG. 16, the device performing the process 1100 of FIG. 11 may correspond to either the UE or the SnMF, and the sensing component performing the process 1200 of FIG. 12 may correspond to either the SnMF or the Wi-Fi AP(s).

Referring to FIGS. 11-12, in a specific example, to reduce or minimize the signaling overhead of depicted in FIG. 16, the SnMF can forward the request to the nearby Wi-Fi AP(s) which can fulfill the UE response. In one aspect, the request is forwarded to a subset of Wi-Fi APs, and the subset of Wi-Fi APs forward their responses to the UE. In another aspect, the SnMF indicates to the UE a list of nearby Wi-Fi APs capable of generating/providing Environment characterization. In an aspect, the UE selects a subset of Wi-Fi APs and send a request to them

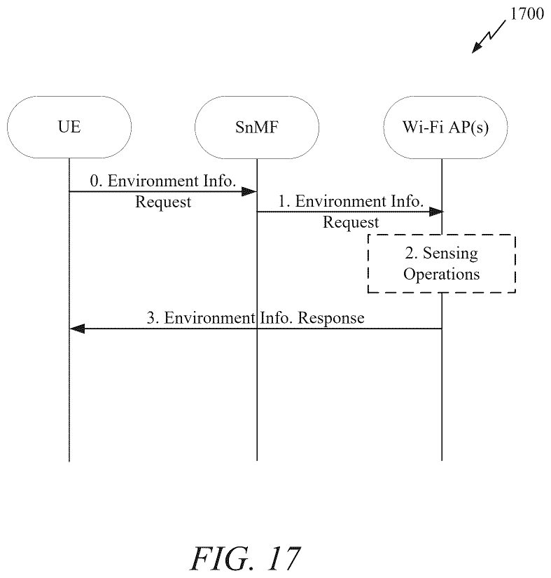

FIG. 17 illustrates an example implementation 1700 of the processes 1100-1200 of FIGS. 11-12, respectively, in accordance with aspects of the disclosure. At (0), the UE transmits an environment request to the SnMF. At (1), the SnMF forwards the UE's environment request to one or more Wi-Fi AP(s). At (2), the Wi-Fi AP(s) (optionally) perform sensing operations to obtain the requested environment information. In an aspect, the sensing operations at (2) are optional because the Wi-Fi AP(s) may already have the requested environment information, and if so, the sensing operations at (2) can be skipped. At (3), the Wi-Fi AP(s) transmit environment information response(s) to the UE that include the requested environment information. Note that in FIG. 16, the device performing the process 1100 of FIG. 11 may correspond to the UE, and the sensing component performing the process 1200 of FIG. 12 may correspond to the Wi-Fi AP(s).

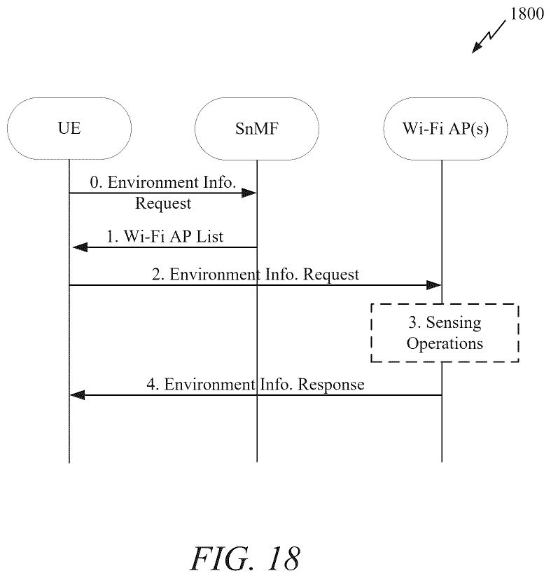

FIG. 18 illustrates an example implementation 1800 of the processes 1100-1200 of FIGS. 11-12, respectively, in accordance with aspects of the disclosure. At (0), the UE transmits an environment request to the SnMF. At (1), instead of fulfilling or mediating the UE's environment request, the SnMF instead sends the UE a Wi-Fi AP list (e.g., so that the UE can reach out to one or more Wi-Fi AP(s) itself to fulfill the environment request). At (2) the UE transmits an environment request to one or more Wi-Fi AP(s) which are selected from the Wi-Fi AP list. At (3), the Wi-Fi AP(s) (optionally) perform sensing operations to obtain the requested environment information. In an aspect, the sensing operations at (3) are optional because the Wi-Fi AP(s) may already have the requested environment information, and if so, the sensing operations at (3) can be skipped. At (4), the Wi-Fi AP(s) transmit environment information response(s) to the UE that include the requested environment information. Note that in FIG. 17, the device performing the process 1100 of FIG. 11 may correspond to the UE, and the sensing component performing the process 1200 of FIG. 12 may correspond to the Wi-Fi AP(s).

Referring to FIGS. 11-12, in a specific example, if one UE has obtained environment information already, that UE could share the environment information with nearby UEs based on their request. In an aspect, a 1^{st} UE with environment information could signal its information in a broadcast beacon. In an aspect, the 1^{st} UE could have obtained the information using any of the previously discussed approaches. In an aspect, a 2^{nd} UE aware of the 1^{st} UE information could request some or all of the environment information for the 1^{st} UE. In an aspect, the environment information could be used by a UE to configure environment-dependent parameters, such as the PRS bandwidth used for SL PRS. In an aspect, the UE-to-UE signaling could be carried over NR SL signaling (e.g., SL-PP or SCI) or another non-3GPP technology (Wi-Fi, Bluetooth Low Energy (BLE), etc.). Note that while described above with respect to UE-to-UE environment information sharing, a similar environment information sharing technique could be implemented between any wireless node type(s) (e.g., UE-to-gNB/TRP, gNB/TRP-to-UE, etc.).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method performed by a device, comprising: transmitting an environment information request; receiving, from a sensing component in response to the environment information request, environment information associated with a wireless node; and performing one or more actions related to a measurement session based on the environment information.

Clause 2. The method of clause 1, wherein the wireless node corresponds to a user equipment (UE) or a wireless network component.

Clause 3. The method of any of clauses 1 to 2, wherein the device corresponds to the wireless node, a user equipment (UE), a wireless network component, a position estimation entity, a location management function (LMF), a location server, or a combination thereof.

Clause 4. The method of any of clauses 1 to 3, wherein the sensing component corresponds to a sensing management component associated with a first network corresponding to a first radio access technology (RAT), or wherein the sensing component corresponds to a sensing node associated with a second network corresponding to a second RAT that is different than the first RAT.

Clause 5. The method of any of clauses 1 to 4, wherein the environment information request is transmitted to the sensing component, or wherein the environment information request is transmitted to a sensing management component that is separate from the sensing component, or wherein the environment information request is transmitted to a network component that is separate from the sensing component and the sensing management component.

Clause 6. The method of any of clauses 1 to 5, wherein the environment information request comprises: an area of interest indication, or a scheduled environment information time, or any combination thereof.

Clause 7. The method of any of clauses 1 to 6, further comprising: receiving an indication of capability information of the sensing component, wherein the environment information request is based on the capability information.

Clause 8. The method of clause 7, wherein the capability information comprises a capability of the device to perform on-demand environment measurements.

Clause 9. The method of any of clauses 7 to 8, wherein the indication of the capability information is signaled via a sensing system information block (SIB), or wherein the indication of the capability information is signaled via dedicated signaling.

Clause 10. The method of any of clauses 1 to 9, wherein some or all of the environment information is obtained by the sensing component before the environment information request is transmitted, or wherein some or all of the environment information is obtained by the sensing component via one or more measurement procedures performed in response to the environment information request, or a combination thereof.

Clause 11. The method of any of clauses 1 to 10, wherein the environment information comprises: tracking object size information, or tracking object motion information, or tracking object type information, or reconfigurable intelligence surface (RIS) information, or channel environment information, or an indication of one of a plurality of channel environment quality tiers, or line of sight (LOS) information or non-LOS (NLOS) information, or delay spread information, or angular spread information, or multipath information, or location profile information, or an indication that one or more environment information types are unavailable, or a reason why the one or more environment information types are unavailable, or any combination thereof.

Clause 12. The method of any of clauses 1 to 11, wherein the environment information is wireless node-specific.

Clause 13. The method of any of clauses 1 to 12, wherein the measurement session comprises: a position estimation session of a user equipment (UE), or a beam management procedure, or a channel state information (CSI) procedure, or a sensing session of one or more target objects, or any combination thereof.

Clause 14. The method of any of clauses 1 to 13, wherein the one or more actions comprises: performing one or more transmissions of one or more first reference signals for positioning (RF-Ps), or performing one or more measurements of one or more second RF-Ps, or selecting an artificial intelligence machine learning model (AIML) model for positioning for generation of one or more inferences based on the one or more measurements, or selecting an AIML model for sensing for generation of at least one inference based on the one or more measurements, or any combination thereof.

Clause 15. The method of any of clauses 1 to 14, further comprising: transmitting, in response to the environment information, an environment information availability message; receiving, in response to the environment information availability message, a request for some or all of the environment information; and transmitting, in response to the request, the requested environment information.

Clause 16. The method of any of clauses 1 to 15, further comprising: transmitting an initial environment information request; receiving an indication of a set of sensing components capable of providing environment information, wherein the environment information request is transmitted to the sensing component in response to the indication of the set of sensing components.

Clause 17. The method of clause 16, wherein the indication of the set of sensing components is received in response to the environment information request.

Clause 18. A method of operating a sensing component, comprising: receiving an environment information request; determining environment information associated wireless node; and transmitting, to a device in response to the environment information request, an indication of the environment information in association with a measurement session.

Clause 19. The method of clause 18, wherein the environment information is obtained before the environment information request is received, or wherein the environment information is obtained in response to the environment information request.

Clause 20. The method of any of clauses 18 to 19, wherein the environment information request is received from a sensing management component associated with a first network corresponding to a first radio access technology (RAT), and wherein the sensing component corresponds to a sensing node associated with a second network corresponding to a second RAT that is different than the first RAT.

Clause 21. The method of any of clauses 18 to 20, wherein the sensing component corresponds a sensing management component associated with a first network corresponding to a first radio access technology (RAT).

Clause 22. The method of clause 21, further comprising: transmitting, to at least one sensing node associated with a second network corresponding to a second RAT that is different than the first RAT, a sensing session request; and receiving, from the at least one sensing node, the environment information in response to the sensing session request.

Clause 23. The method of clause 22, wherein the at least one sensing node comprises multiple sensing nodes, and wherein the environment information transmitted to the device is aggregated from the environment information received from each of the multiple sensing nodes.

Clause 24. The method of any of clauses 18 to 23, wherein the wireless node corresponds to a user equipment (UE) or a wireless network component.

Clause 25. The method of any of clauses 18 to 24, wherein the device corresponds to the wireless node, a user equipment (UE), a wireless network component, a position estimation entity, a location management function (LMF), a location server, or a combination thereof.

Clause 26. The method of any of clauses 18 to 25, wherein the environment information request comprises: an area of interest indication, or a scheduled environment information time, or any combination thereof.

Clause 27. The method of any of clauses 18 to 26, further comprising: transmitting an indication of capability information of the sensing component, wherein the environment information request is based on the capability information.

Clause 28. The method of clause 27, wherein the capability information comprises a capability of the device to perform on-demand environment measurements.

Clause 29. The method of any of clauses 27 to 28, wherein the indication of the capability information is signaled via a sensing system information block (SIB), or wherein the indication of the capability information is signaled via dedicated signaling.

Clause 30. The method of any of clauses 18 to 29, wherein the environment information comprises: tracking object size information, or tracking object motion information, or tracking object type information, or reconfigurable intelligence surface (RIS) information, or channel environment information, or an indication of one of a plurality of channel environment quality tiers, or line of sight (LOS) information or non-LOS (NLOS) information, or delay spread information, or angular spread information, or multipath information, or location profile information, or an indication that one or more environment information types are unavailable, or a reason why the one or more environment information types are unavailable, or any combination thereof.

Clause 31. The method of any of clauses 18 to 30, wherein the environment information is wireless node-specific.

Clause 32. The method of any of clauses 18 to 31, wherein the measurement session comprises: a position estimation session of a user equipment (UE), or a beam management procedure, or a channel state information (CSI) procedure, or a sensing session of one or more target objects, or any combination thereof.

Clause 33. A device, comprising: one or more memories; one or more transceivers; and one or more processors communicatively coupled to the one or more memories and the one or more transceivers, the one or more processors, either alone or in combination, being configured to: transmit, via the one or more transceivers, an environment information request; receive, via the one or more transceivers, from a sensing component in response to the environment information request, environment information associated with a wireless node; and perform one or more actions related to a measurement session based on the environment information.

Clause 34. The device of clause 33, wherein the wireless node corresponds to a user equipment (UE) or a wireless network component.

Clause 35. The device of any of clauses 33 to 34, wherein the device corresponds to the wireless node, a user equipment (UE), a wireless network component, a position estimation entity, a location management function (LMF), a location server, or a combination thereof.

Clause 36. The device of any of clauses 33 to 35, wherein the sensing component corresponds to a sensing management component associated with a first network corresponding to a first radio access technology (RAT), or wherein the sensing component corresponds to a sensing node associated with a second network corresponding to a second RAT that is different than the first RAT.

Clause 37. The device of any of clauses 33 to 36, wherein the environment information request is transmitted to the sensing component, or wherein the environment information request is transmitted to a sensing management component that is separate from the sensing component, or wherein the environment information request is transmitted to a network component that is separate from the sensing component and the sensing management component.

Clause 38. The device of any of clauses 33 to 37, wherein the environment information request comprises: an area of interest indication, or a scheduled environment information time, or any combination thereof.

Clause 39. The device of any of clauses 33 to 38, wherein the one or more processors, either alone or in combination, are further configured to: receive, via the one or more transceivers, an indication of capability information of the sensing component, wherein the environment information request is based on the capability information.

Clause 40. The device of clause 39, wherein the capability information comprises a capability of the device to perform on-demand environment measurements.

Clause 41. The device of any of clauses 39 to 40, wherein the indication of the capability information is signaled via a sensing system information block (SIB), or wherein the indication of the capability information is signaled via dedicated signaling.

Clause 42. The device of any of clauses 33 to 41, wherein some or all of the environment information is obtained by the sensing component before the environment information request is transmitted, or wherein some or all of the environment information is obtained by the sensing component via one or more measurement procedures performed in response to the environment information request, or a combination thereof.

Clause 43. The device of any of clauses 33 to 42, wherein the environment information comprises: track object size information, or track object motion information, or tracking object type information, or reconfigurable intelligence surface (RIS) information, or channel environment information, or an indication of one of a plurality of channel environment quality tiers, or line of sight (LOS) information or non-LOS (NLOS) information, or delay spread information, or angular spread information, or multipath information, or location profile information, or an indication that one or more environment information types are unavailable, or a reason why the one or more environment information types are unavailable, or any combination thereof.

Clause 44. The device of any of clauses 33 to 43, wherein the environment information is wireless node-specific.

Clause 45. The device of any of clauses 33 to 44, wherein the measurement session comprises: a position estimation session of a user equipment (UE), or a beam management procedure, or a channel state information (CSI) procedure, or a sensing session of one or more target objects, or any combination thereof.

Clause 46. The device of any of clauses 33 to 45, wherein the one or more actions comprises: perform one or more transmissions of one or more first reference signals for positioning (RF-Ps), or perform one or more measurements of one or more second RF-Ps, or select an artificial intelligence machine learning model (AIML) model for positioning for generation of one or more inferences based on the one or more measurements, or select an AIML model for sensing for generation of at least one inference based on the one or more measurements, or any combination thereof.

Clause 47. The device of any of clauses 33 to 46, wherein the one or more processors, either alone or in combination, are further configured to: transmit, via the one or more transceivers, in response to the environment information, an environment information availability message; receive, via the one or more transceivers, in response to the environment information availability message, a request for some or all of the environment information; and transmit, via the one or more transceivers, in response to the request, the requested environment information.

Clause 48. The device of any of clauses 33 to 47, wherein the one or more processors, either alone or in combination, are further configured to: transmit, via the one or more transceivers, an initial environment information request; receive, via the one or more transceivers, an indication of a set of sensing components capable of providing environment information, wherein the environment information request is transmitted to the sensing component in response to the indication of the set of sensing components.

Clause 49. The device of clause 48, wherein the indication of the set of sensing components is received in response to the environment information request.

Clause 50. A sensing component, comprising: one or more memories; one or more transceivers; and one or more processors communicatively coupled to the one or more memories and the one or more transceivers, the one or more processors, either alone or in combination, being configured to: receive, via the one or more transceivers, an environment information request; determine environment information associated wireless node; and transmit, via the one or more transceivers, to a device in response to the environment information request, an indication of the environment information in association with a measurement session.

Clause 51. The sensing component of clause 50, wherein the environment information is obtained before the environment information request is received, or wherein the environment information is obtained in response to the environment information request.

Clause 52. The sensing component of any of clauses 50 to 51, wherein the environment information request is received from a sensing management component associated with a first network corresponding to a first radio access technology (RAT), and wherein the sensing component corresponds to a sensing node associated with a second network corresponding to a second RAT that is different than the first RAT.

Clause 53. The sensing component of any of clauses 50 to 52, wherein the sensing component corresponds a sensing management component associated with a first network corresponding to a first radio access technology (RAT).

Clause 54. The sensing component of clause 53, wherein the one or more processors, either alone or in combination, are further configured to: transmit, via the one or more transceivers, to at least one sensing node associated with a second network corresponding to a second RAT that is different than the first RAT, a sensing session request; and receive, via the one or more transceivers, from the at least one sensing node, the environment information in response to the sensing session request.

Clause 55. The sensing component of clause 54, wherein the at least one sensing node comprises multiple sensing nodes, and wherein the environment information transmitted to the device is aggregated from the environment information received from each of the multiple sensing nodes.

Clause 56. The sensing component of any of clauses 50 to 55, wherein the wireless node corresponds to a user equipment (UE) or a wireless network component.

Clause 57. The sensing component of any of clauses 50 to 56, wherein the device corresponds to the wireless node, a user equipment (UE), a wireless network component, a position estimation entity, a location management function (LMF), a location server, or a combination thereof.

Clause 58. The sensing component of any of clauses 50 to 57, wherein the environment information request comprises: an area of interest indication, or a scheduled environment information time, or any combination thereof.

Clause 59. The sensing component of any of clauses 50 to 58, wherein the one or more processors, either alone or in combination, are further configured to: transmit, via the one or more transceivers, an indication of capability information of the sensing component, wherein the environment information request is based on the capability information.

Clause 60. The sensing component of clause 59, wherein the capability information comprises a capability of the device to perform on-demand environment measurements.

Clause 61. The sensing component of any of clauses 59 to 60, wherein the indication of the capability information is signaled via a sensing system information block (SIB), or wherein the indication of the capability information is signaled via dedicated signaling.

Clause 62. The sensing component of any of clauses 50 to 61, wherein the environment information comprises: track object size information, or track object motion information, or tracking object type information, or reconfigurable intelligence surface (RIS) information, or channel environment information, or an indication of one of a plurality of channel environment quality tiers, or line of sight (LOS) information or non-LOS (NLOS) information, or delay spread information, or angular spread information, or multipath information, or location profile information, or an indication that one or more environment information types are unavailable, or a reason why the one or more environment information types are unavailable, or any combination thereof.

Clause 63. The sensing component of any of clauses 50 to 62, wherein the environment information is wireless node-specific.

Clause 64. The sensing component of any of clauses 50 to 63, wherein the measurement session comprises: a position estimation session of a user equipment (UE), or a beam management procedure, or a channel state information (CSI) procedure, or a sensing session of one or more target objects, or any combination thereof.

Clause 65. A device, comprising: means for transmitting an environment information request; means for receiving, from a sensing component in response to the environment information request, environment information associated with a wireless node; and means for performing one or more actions related to a measurement session based on the environment information.

Clause 66. The device of clause 65, wherein the wireless node corresponds to a user equipment (UE) or a wireless network component.

Clause 67. The device of any of clauses 65 to 66, wherein the device corresponds to the wireless node, a user equipment (UE), a wireless network component, a position estimation entity, a location management function (LMF), a location server, or a combination thereof.

Clause 68. The device of any of clauses 65 to 67, wherein the sensing component corresponds to a sensing management component associated with a first network corresponding to a first radio access technology (RAT), or wherein the sensing component corresponds to a sensing node associated with a second network corresponding to a second RAT that is different than the first RAT.

Clause 69. The device of any of clauses 65 to 68, wherein the environment information request is transmitted to the sensing component, or wherein the environment information request is transmitted to a sensing management component that is separate from the sensing component, or wherein the environment information request is transmitted to a network component that is separate from the sensing component and the sensing management component.

Clause 70. The device of any of clauses 65 to 69, wherein the environment information request comprises: an area of interest indication, or a scheduled environment information time, or any combination thereof.

Clause 71. The device of any of clauses 65 to 70, further comprising: means for receiving an indication of capability information of the sensing component, wherein the environment information request is based on the capability information.

Clause 72. The device of clause 71, wherein the capability information comprises a capability of the device to perform on-demand environment measurements.

Clause 73. The device of any of clauses 71 to 72, wherein the indication of the capability information is signaled via a sensing system information block (SIB), or wherein the indication of the capability information is signaled via dedicated signaling.

Clause 74. The device of any of clauses 65 to 73, wherein some or all of the environment information is obtained by the sensing component before the environment information request is transmitted, or wherein some or all of the environment information is obtained by the sensing component via one or more measurement procedures performed in response to the environment information request, or a combination thereof.

Clause 75. The device of any of clauses 65 to 74, wherein the environment information comprises: means for tracking object size information, or means for tracking object motion information, or tracking object type information, or reconfigurable intelligence surface (RIS) information, or channel environment information, or an indication of one of a plurality of channel environment quality tiers, or line of sight (LOS) information or non-LOS (NLOS) information, or delay spread information, or angular spread information, or multipath information, or location profile information, or an indication that one or more environment information types are unavailable, or a reason why the one or more environment information types are unavailable, or any combination thereof.

Clause 76. The device of any of clauses 65 to 75, wherein the environment information is wireless node-specific.

Clause 77. The device of any of clauses 65 to 76, wherein the measurement session comprises: a position estimation session of a user equipment (UE), or a beam management procedure, or a channel state information (CSI) procedure, or a sensing session of one or more target objects, or any combination thereof.

Clause 78. The device of any of clauses 65 to 77, wherein the one or more actions comprises: means for performing one or more transmissions of one or more first reference signals for positioning (RF-Ps), or means for performing one or more measurements of one or more second RF-Ps, or means for selecting an artificial intelligence machine learning model (AIML) model for positioning for generation of one or more inferences based on the one or more measurements, or means for selecting an AIML model for sensing for generation of at least one inference based on the one or more measurements, or any combination thereof.

Clause 79. The device of any of clauses 65 to 78, further comprising: means for transmitting, in response to the environment information, an environment information availability message; means for receiving, in response to the environment information availability message, a request for some or all of the environment information; and means for transmitting, in response to the request, the requested environment information.

Clause 80. The device of any of clauses 65 to 79, further comprising: means for transmitting an initial environment information request; means for receiving an indication of a set of sensing components capable of providing environment information, wherein the environment information request is transmitted to the sensing component in response to the indication of the set of sensing components.

Clause 81. The device of clause 80, wherein the indication of the set of sensing components is received in response to the environment information request.

Clause 82. A sensing component, comprising: means for receiving an environment information request; means for determining environment information associated wireless node; and means for transmitting, to a device in response to the environment information request, an indication of the environment information in association with a measurement session.

Clause 83. The sensing component of clause 82, wherein the environment information is obtained before the environment information request is received, or wherein the environment information is obtained in response to the environment information request.

Clause 84. The sensing component of any of clauses 82 to 83, wherein the environment information request is received from a sensing management component associated with a first network corresponding to a first radio access technology (RAT), and wherein the sensing component corresponds to a sensing node associated with a second network corresponding to a second RAT that is different than the first RAT.

Clause 85. The sensing component of any of clauses 82 to 84, wherein the sensing component corresponds a sensing management component associated with a first network corresponding to a first radio access technology (RAT).

Clause 86. The sensing component of clause 85, further comprising: means for transmitting, to at least one sensing node associated with a second network corresponding to a second RAT that is different than the first RAT, a sensing session request; and means for receiving, from the at least one sensing node, the environment information in response to the sensing session request.

Clause 87. The sensing component of clause 86, wherein the at least one sensing node comprises multiple sensing nodes, and wherein the environment information transmitted to the device is aggregated from the environment information received from each of the multiple sensing nodes.

Clause 88. The sensing component of any of clauses 82 to 87, wherein the wireless node corresponds to a user equipment (UE) or a wireless network component.

Clause 89. The sensing component of any of clauses 82 to 88, wherein the device corresponds to the wireless node, a user equipment (UE), a wireless network component, a position estimation entity, a location management function (LMF), a location server, or a combination thereof.

Clause 90. The sensing component of any of clauses 82 to 89, wherein the environment information request comprises: an area of interest indication, or a scheduled environment information time, or any combination thereof.

Clause 91. The sensing component of any of clauses 82 to 90, further comprising: means for transmitting an indication of capability information of the sensing component, wherein the environment information request is based on the capability information.

Clause 92. The sensing component of clause 91, wherein the capability information comprises a capability of the device to perform on-demand environment measurements.

Clause 93. The sensing component of any of clauses 91 to 92, wherein the indication of the capability information is signaled via a sensing system information block (SIB), or wherein the indication of the capability information is signaled via dedicated signaling.

Clause 94. The sensing component of any of clauses 82 to 93, wherein the environment information comprises: means for tracking object size information, or means for tracking object motion information, or tracking object type information, or reconfigurable intelligence surface (RIS) information, or channel environment information, or an indication of one of a plurality of channel environment quality tiers, or line of sight (LOS) information or non-LOS (NLOS) information, or delay spread information, or angular spread information, or multipath information, or location profile information, or an indication that one or more environment information types are unavailable, or a reason why the one or more environment information types are unavailable, or any combination thereof.

Clause 95. The sensing component of any of clauses 82 to 94, wherein the environment information is wireless node-specific.

Clause 96. The sensing component of any of clauses 82 to 95, wherein the measurement session comprises: a position estimation session of a user equipment (UE), or a beam management procedure, or a channel state information (CSI) procedure, or a sensing session of one or more target objects, or any combination thereof.

Clause 97. A non-transitory computer-readable medium storing computer-executable instructions that, when executed by a device, cause the device to: transmit an environment information request; receive, from a sensing component in response to the environment information request, environment information associated with a wireless node; and perform one or more actions related to a measurement session based on the environment information.

Clause 98. The non-transitory computer-readable medium of clause 97, wherein the wireless node corresponds to a user equipment (UE) or a wireless network component.

Clause 99. The non-transitory computer-readable medium of any of clauses 97 to 98, wherein the device corresponds to the wireless node, a user equipment (UE), a wireless network component, a position estimation entity, a location management function (LMF), a location server, or a combination thereof.

Clause 100. The non-transitory computer-readable medium of any of clauses 97 to 99, wherein the sensing component corresponds to a sensing management component associated with a first network corresponding to a first radio access technology (RAT), or wherein the sensing component corresponds to a sensing node associated with a second network corresponding to a second RAT that is different than the first RAT.

Clause 101. The non-transitory computer-readable medium of any of clauses 97 to 100, wherein the environment information request is transmitted to the sensing component, or wherein the environment information request is transmitted to a sensing management component that is separate from the sensing component, or wherein the environment information request is transmitted to a network component that is separate from the sensing component and the sensing management component.

Clause 102. The non-transitory computer-readable medium of any of clauses 97 to 101, wherein the environment information request comprises: an area of interest indication, or a scheduled environment information time, or any combination thereof.

Clause 103. The non-transitory computer-readable medium of any of clauses 97 to 102, further comprising computer-executable instructions that, when executed by the device, cause the device to: receive an indication of capability information of the sensing component, wherein the environment information request is based on the capability information.

Clause 104. The non-transitory computer-readable medium of clause 103, wherein the capability information comprises a capability of the device to perform on-demand environment measurements.

Clause 105. The non-transitory computer-readable medium of any of clauses 103 to 104, wherein the indication of the capability information is signaled via a sensing system information block (SIB), or wherein the indication of the capability information is signaled via dedicated signaling.

Clause 106. The non-transitory computer-readable medium of any of clauses 97 to 105, wherein some or all of the environment information is obtained by the sensing component before the environment information request is transmitted, or wherein some or all of the environment information is obtained by the sensing component via one or more measurement procedures performed in response to the environment information request, or a combination thereof.

Clause 107. The non-transitory computer-readable medium of any of clauses 97 to 106, wherein the environment information comprises: track object size information, or track object motion information, or tracking object type information, or reconfigurable intelligence surface (RIS) information, or channel environment information, or an indication of one of a plurality of channel environment quality tiers, or line of sight (LOS) information or non-LOS (NLOS) information, or delay spread information, or angular spread information, or multipath information, or location profile information, or an indication that one or more environment information types are unavailable, or a reason why the one or more environment information types are unavailable, or any combination thereof.

Clause 108. The non-transitory computer-readable medium of any of clauses 97 to 107, wherein the environment information is wireless node-specific.

Clause 109. The non-transitory computer-readable medium of any of clauses 97 to 108, wherein the measurement session comprises: a position estimation session of a user equipment (UE), or a beam management procedure, or a channel state information (CSI) procedure, or a sensing session of one or more target objects, or any combination thereof.

Clause 110. The non-transitory computer-readable medium of any of clauses 97 to 109, wherein the one or more actions comprises: perform one or more transmissions of one or more first reference signals for positioning (RF-Ps), or perform one or more measurements of one or more second RF-Ps, or select an artificial intelligence machine learning model (AIML) model for positioning for generation of one or more inferences based on the one or more measurements, or select an AIML model for sensing for generation of at least one inference based on the one or more measurements, or any combination thereof.

Clause 111. The non-transitory computer-readable medium of any of clauses 97 to 110, further comprising computer-executable instructions that, when executed by the device, cause the device to: transmit, in response to the environment information, an environment information availability message; receive, in response to the environment information availability message, a request for some or all of the environment information; and transmit, in response to the request, the requested environment information.

Clause 112. The non-transitory computer-readable medium of any of clauses 97 to 111, further comprising computer-executable instructions that, when executed by the device, cause the device to: transmit an initial environment information request; receive an indication of a set of sensing components capable of providing environment information, wherein the environment information request is transmitted to the sensing component in response to the indication of the set of sensing components.

Clause 113. The non-transitory computer-readable medium of clause 112, wherein the indication of the set of sensing components is received in response to the environment information request.

Clause 114. A non-transitory computer-readable medium storing computer-executable instructions that, when executed by a sensing component, cause the sensing component to: receive an environment information request; determine environment information associated wireless node; and transmit, to a device in response to the environment information request, an indication of the environment information in association with a measurement session.

Clause 115. The non-transitory computer-readable medium of clause 114, wherein the environment information is obtained before the environment information request is received, or wherein the environment information is obtained in response to the environment information request.

Clause 116. The non-transitory computer-readable medium of any of clauses 114 to 115, wherein the environment information request is received from a sensing management component associated with a first network corresponding to a first radio access technology (RAT), and wherein the sensing component corresponds to a sensing node associated with a second network corresponding to a second RAT that is different than the first RAT.

Clause 117. The non-transitory computer-readable medium of any of clauses 114 to 116, wherein the sensing component corresponds a sensing management component associated with a first network corresponding to a first radio access technology (RAT).

Clause 118. The non-transitory computer-readable medium of clause 117, further comprising computer-executable instructions that, when executed by the sensing component, cause the sensing component to: transmit, to at least one sensing node associated with a second network corresponding to a second RAT that is different than the first RAT, a sensing session request; and receive, from the at least one sensing node, the environment information in response to the sensing session request.

Clause 119. The non-transitory computer-readable medium of clause 118, wherein the at least one sensing node comprises multiple sensing nodes, and wherein the environment information transmitted to the device is aggregated from the environment information received from each of the multiple sensing nodes.

Clause 120. The non-transitory computer-readable medium of any of clauses 114 to 119, wherein the wireless node corresponds to a user equipment (UE) or a wireless network component.

Clause 121. The non-transitory computer-readable medium of any of clauses 114 to 120, wherein the device corresponds to the wireless node, a user equipment (UE), a wireless network component, a position estimation entity, a location management function (LMF), a location server, or a combination thereof.

Clause 122. The non-transitory computer-readable medium of any of clauses 114 to 121, wherein the environment information request comprises: an area of interest indication, or a scheduled environment information time, or any combination thereof.

Clause 123. The non-transitory computer-readable medium of any of clauses 114 to 122, further comprising computer-executable instructions that, when executed by the sensing component, cause the sensing component to: transmit an indication of capability information of the sensing component, wherein the environment information request is based on the capability information.

Clause 124. The non-transitory computer-readable medium of clause 123, wherein the capability information comprises a capability of the device to perform on-demand environment measurements.

Clause 125. The non-transitory computer-readable medium of any of clauses 123 to 124, wherein the indication of the capability information is signaled via a sensing system information block (SIB), or wherein the indication of the capability information is signaled via dedicated signaling.

Clause 126. The non-transitory computer-readable medium of any of clauses 114 to 125, wherein the environment information comprises: track object size information, or track object motion information, or tracking object type information, or reconfigurable intelligence surface (RIS) information, or channel environment information, or an indication of one of a plurality of channel environment quality tiers, or line of sight (LOS) information or non-LOS (NLOS) information, or delay spread information, or angular spread information, or multipath information, or location profile information, or an indication that one or more environment information types are unavailable, or a reason why the one or more environment information types are unavailable, or any combination thereof.

Clause 127. The non-transitory computer-readable medium of any of clauses 114 to 126, wherein the environment information is wireless node-specific.

Clause 128. The non-transitory computer-readable medium of any of clauses 114 to 127, wherein the measurement session comprises: a position estimation session of a user equipment (UE), or a beam management procedure, or a channel state information (CSI) procedure, or a sensing session of one or more target objects, or any combination thereof.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A device, comprising:
one or more memories;
one or more transceivers; and
one or more processors communicatively coupled to the one or more memories and the one or more transceivers, the one or more processors, either alone or in combination, being configured to:
transmit, via the one or more transceivers, an environment information request;
receive, via the one or more transceivers, from a sensing component in response to the environment information request, environment information associated with a wireless node; and
perform one or more actions related to a measurement session based on the environment information.

2. The device of claim 1, wherein the wireless node corresponds to a user equipment (UE) or a wireless network component.

3. The device of claim 1, wherein the device corresponds to the wireless node, a user equipment (UE), a wireless network component, a position estimation entity, a location management function (LMF), a location server, or a combination thereof.

4. The device of claim 1,
wherein the sensing component corresponds to a sensing management component associated with a first network corresponding to a first radio access technology (RAT), or
wherein the sensing component corresponds to a sensing node associated with a second network corresponding to a second RAT that is different than the first RAT.

5. The device of claim 1,
wherein the environment information request is transmitted to the sensing component, or
wherein the environment information request is transmitted to a sensing management component that is separate from the sensing component, or
wherein the environment information request is transmitted to a network component that is separate from the sensing component and the sensing management component.

6. The device of claim 1, wherein the environment information request comprises:
an area of interest indication, or
a scheduled environment information time, or
any combination thereof.

7. The device of claim 1, wherein the one or more processors, either alone or in combination, are further configured to:
receive, via the one or more transceivers, an indication of capability information of the sensing component,
wherein the environment information request is based on the capability information.

8. The device of claim 7, wherein the capability information comprises a capability of the device to perform on-demand environment measurements.

9. The device of claim 7,
wherein the indication of the capability information is signaled via a sensing system information block (SIB), or
wherein the indication of the capability information is signaled via dedicated signaling.

10. The device of claim 1,
wherein some or all of the environment information is obtained by the sensing component before the environment information request is transmitted, or
wherein some or all of the environment information is obtained by the sensing component via one or more measurement procedures performed in response to the environment information request, or
a combination thereof.

11. The device of claim 1, wherein the environment information comprises:
track object size information, or
track object motion information, or
tracking object type information, or
reconfigurable intelligence surface (RIS) information, or
channel environment information, or
an indication of one of a plurality of channel environment quality tiers, or
line of sight (LOS) information or non-LOS (NLOS) information, or
delay spread information, or
angular spread information, or
multipath information, or
location profile information, or
an indication that one or more environment information types are unavailable, or
a reason why the one or more environment information types are unavailable, or
any combination thereof.

12. The device of claim 1, wherein the environment information is wireless node-specific.

13. The device of claim 1, wherein the measurement session comprises:
a position estimation session of a user equipment (UE), or
a beam management procedure, or
a channel state information (CSI) procedure, or
a sensing session of one or more target objects, or
any combination thereof.

14. The device of claim 1, wherein the one or more actions comprises:
perform one or more transmissions of one or more first reference signals for positioning (RF-Ps), or
perform one or more measurements of one or more second RF-Ps, or
select an artificial intelligence machine learning model (AIML) model for positioning for generation of one or more inferences based on the one or more measurements, or
select an AIML model for sensing for generation of at least one inference based on the one or more measurements, or
any combination thereof.

15. The device of claim 1, wherein the one or more processors, either alone or in combination, are further configured to:
transmit, via the one or more transceivers, in response to the environment information, an environment information availability message;
receive, via the one or more transceivers, in response to the environment information availability message, a request for some or all of the environment information; and
transmit, via the one or more transceivers, in response to the request, the requested environment information.

16. The device of claim 1, wherein the one or more processors, either alone or in combination, are further configured to:
transmit, via the one or more transceivers, an initial environment information request; and
receive, via the one or more transceivers, an indication of a set of sensing components capable of providing environment information,
wherein the environment information request is transmitted to the sensing component in response to the indication of the set of sensing components.

17. The device of claim 16, wherein the indication of the set of sensing components is received in response to the environment information request.

18. A sensing component, comprising:
one or more memories;
one or more transceivers; and
one or more processors communicatively coupled to the one or more memories and the one or more transceivers, the one or more processors, either alone or in combination, being configured to:
receive, via the one or more transceivers, an environment information request;
determine environment information associated wireless node; and
transmit, via the one or more transceivers, to a device in response to the environment information request, an indication of the environment information in association with a measurement session.

19. The sensing component of claim 18,
wherein the environment information is obtained before the environment information request is received, or
wherein the environment information is obtained in response to the environment information request.

20. The sensing component of claim 18,
wherein the environment information request is received from a sensing management component associated with a first network corresponding to a first radio access technology (RAT), and
wherein the sensing component corresponds to a sensing node associated with a second network corresponding to a second RAT that is different than the first RAT.

21. The sensing component of claim 18, wherein the sensing component corresponds a sensing management component associated with a first network corresponding to a first radio access technology (RAT).

22. The sensing component of claim 21, wherein the one or more processors, either alone or in combination, are further configured to:
transmit, via the one or more transceivers, to at least one sensing node associated with a second network corresponding to a second RAT that is different than the first RAT, a sensing session request; and
receive, via the one or more transceivers, from the at least one sensing node, the environment information in response to the sensing session request.

23. The sensing component of claim 22,
wherein the at least one sensing node comprises multiple sensing nodes, and
wherein the environment information transmitted to the device is aggregated from the environment information received from each of the multiple sensing nodes.

24. The sensing component of claim 18,
wherein the wireless node corresponds to a user equipment (UE) or a wireless network component, or
wherein the device corresponds to the wireless node, a user equipment (UE), a wireless network component, a position estimation entity, a location management function (LMF), a location server, or a combination thereof, or
wherein the environment information request comprises:
an area of interest indication, or
a scheduled environment information time, or
any combination thereof.

25. The sensing component of claim 18, wherein the one or more processors, either alone or in combination, are further configured to:
transmit, via the one or more transceivers, an indication of capability information of the sensing component,
wherein the environment information request is based on the capability information.

26. The sensing component of claim 25,
wherein the capability information comprises a capability of the device to perform on-demand environment measurements, or
wherein the indication of the capability information is signaled via a sensing system information block (SIB), or
wherein the indication of the capability information is signaled via dedicated signaling.

27. The sensing component of claim 18, wherein the environment information comprises:
track object size information, or
track object motion information, or
tracking object type information, or
reconfigurable intelligence surface (RIS) information, or
channel environment information, or
an indication of one of a plurality of channel environment quality tiers, or
line of sight (LOS) information or non-LOS (NLOS) information, or
delay spread information, or
angular spread information, or
multipath information, or
location profile information, or
an indication that one or more environment information types are unavailable, or
a reason why the one or more environment information types are unavailable, or
any combination thereof.

28. The sensing component of claim 18,
wherein the environment information is wireless node-specific, or
wherein the measurement session comprises:
a position estimation session of a user equipment (UE), or
a beam management procedure, or
a channel state information (CSI) procedure, or
a sensing session of one or more target objects, or
any combination thereof.

29. A method performed by a device, comprising:
transmitting an environment information request;
receiving, from a sensing component in response to the environment information request, environment information associated with a wireless node; and
performing one or more actions related to a measurement session based on the environment information.

30. A method of operating a sensing component, comprising:
receiving an environment information request;
determining environment information associated wireless node; and
transmitting, to a device in response to the environment information request, an indication of the environment information in association with a measurement session.
